(19) United States
(12) Patent Application Publication
(10) Pub. No.: US 2025/0013362 A1
(43) Pub. Date: Jan. 9, 2025

(54) INFORMATION PROCESSING APPARATUS AND CONTROL METHOD

(71) Applicant: Lenovo (Singapore) Pte. Ltd., Singapore (SG)

(72) Inventors: Yoshinori Ito, Kanagawa (JP); Yuichi Sone, Kanagawa (JP)

(73) Assignee: Lenovo (Singapore) Pte. Ltd., Singapore (SG)

(21) Appl. No.: 18/758,489

(22) Filed: Jun. 28, 2024

(30) Foreign Application Priority Data
Jul. 5, 2023 (JP) 2023-110457

(51) Int. Cl. G06F 3/04886; G06F 1/16; G06F 3/02

(52) U.S. Cl. CPC G06F 3/04886; G06F 1/1616; G06F 3/0202; G06F 2203/04803

(57) ABSTRACT

An information processing apparatus includes: a memory which temporarily stores a program of an application; a display; and a processor which executes the program of the application stored in the memory to perform control to display a window of the application on the display. The processor performs: mounting detection processing to detect mounting of an external keyboard on a predetermined screen area within a screen area of the display, and display control processing to control switching among a first display mode in which display is controlled using an entire screen area of the display as one display area, a second display mode in which the display is controlled by splitting the screen area of the display into two or more display areas, and a third display mode in which, when the mounting of the keyboard is detected by the mounting detection processing, the display is controlled.

### CROSS-REFERENCE TO RELATED APPLICATIONS

This application claims priority to Japanese Patent Application No. 2023-110457 filed on Jul. 5, 2023, the contents of which are hereby incorporated herein by reference in their entirety.

### TECHNICAL FIELD

The present invention relates to an information processing apparatus and a control method.

### BACKGROUND

In recent years, an information processing apparatus in which a foldable flexible display (display unit) is provided over a first chassis and a second chassis in a manner to be bendable according to the rotation of the first chassis and the second chassis has been disclosed (for example, see Japanese Unexamined Patent Application Publication No. 2018-013850). When one display is provided over the first chassis and the second chassis in this way, it is possible not only to use the one display as a one-screen mode but also to use the one display as a two-screen mode in a pseudo manner by splitting the display area of the one display into a display area on the side of the first chassis and a display area on the side of the second chassis.

In the information processing apparatus as described above, since one display is provided over the first chassis and the second chassis, it is common that the information processing apparatus is not equipped with any keyboard, but there is an information processing apparatus that can mount an external keyboard on one screen and set only the other screen as a display area in the two-screen mode to set up the information processing apparatus in a usage form similar to that of a laptop PC (Personal Computer) equipped with a keyboard. When the usage form similar to that of the laptop PC is also possible in this way, since the degree of freedom when a user uses the information processing apparatus increases, it is highly convenient.

For example, when the external keyboard is mounted, the information processing apparatus controls a screen area on the side where the external keyboard is mounted to black display or the like, and automatically switches to a screen mode to control display by setting a screen area on the other side as a screen half the size of the screen in the one-screen mode (hereinafter called a “half-screen mode”). At this time, a window of an application displayed before switching to the half-screen mode is rearranged in a half-screen area, for example, under the control of an OS (Operating System) or the like. For example, when an active window is displayed in a screen area on the side where the keyboard is mounted before switching to the half-screen mode, the active window is displayed in a screen area on the other side in response to switching to the half-screen mode.

However, when a user mounts the external keyboard, if the display state of the window in the screen area on the side where the keyboard is not mounted changes, there will be a concern that the user will feel uncomfortable.

### SUMMARY

One or more embodiments of the present invention provide an information processing apparatus and a control method to control display properly when controlling the display by splitting the screen area of a display screen into two or more areas.

An information processing apparatus according to one or more embodiments of the present invention includes: a memory which temporarily stores a program of an application; a display; and a processor which executes the program of the application stored in the memory to perform control to display a window of the application on the display, wherein the processor performs mounting detection processing to detect the mounting of an external keyboard on a predetermined screen area within a screen area of the display, and display control processing to control switching among a first display mode in which display is controlled using the entire screen area of the display as one display area, a second display mode in which the display is controlled by splitting the screen area of the display into two or more display areas, and a third display mode in which, when the mounting of the keyboard is detected by the mounting detection processing, the display is controlled using, as a display area, a first screen area as part of the screen area of the display except the predetermined screen area, and in the display control processing, when switching from the second display mode to the third display mode, the processor arranges or minimizes, in the first screen area, a window displayed in a display area other than the first screen area in the second display mode, and when arranging the window in the first screen area, the processor arranges the window on a layer lower than a window displayed on the top layer of the first screen area in the second display mode.

The above information processing apparatus may be such that, in the display control processing, when an active window is displayed in a display area other than the first screen area in the second display mode, the processor switches, to an active window, the window displayed on the top layer of the first screen area in the second display mode in response to switching from the second display mode to the third display mode.

The above information processing apparatus may also be such that, in the display control processing, when the display is controlled by splitting the display area other than the first screen area into two or more display areas in the second display mode, the processor arranges or minimizes windows, displayed respectively in the two or more display areas other than the first screen area in the second display mode, on layers lower than the window displayed on the top layer of the first screen area in the second display mode in response to switching from the second display mode to the third display mode.

The above information processing apparatus may further be such that, in the display control processing, when the display is controlled by splitting the first screen area into two or more display areas in the second display mode, the processor arranges or minimizes a window, displayed in the display area other than the first screen area in the second display mode, on a layer lower than windows displayed on the top layers of the respective display areas inside the first screen area in the second display mode in response to switching from the second display mode to the third display mode.

Further, the above information processing apparatus may be such that, in the display control processing, when the display is controlled by splitting the first screen area and the display area other than the first screen area respectively into two or more display areas in the second display mode, the processor arranges or minimizes windows, displayed respectively in the two or more display areas other than the first screen area in the second display mode, on layers lower than windows displayed on the top layers of the respective display areas inside the first screen area in the second display mode in response to switching from the second display mode to the third display mode.

Further, an information processing apparatus according to the second aspect of the present invention includes: a memory which temporarily stores a program of an application; a display; and a processor which executes the program of the application stored in the memory to perform control to display a window of the application on the display, wherein the processor performs mounting detection processing to detect the mounting of an external keyboard on a predetermined screen area within a screen area of the display, and display control processing to control switching among a first display mode in which display is controlled using the entire screen area of the display as one display area, a second display mode in which the display is controlled by splitting the screen area of the display into two or more display areas, and a third display mode in which, when the mounting of the keyboard is detected by the mounting detection processing, the display is controlled using, as a display area, a first screen area as part of the screen area of the display except the predetermined screen area, and in the display control processing, when an active window is displayed in a display area other than the first screen area in the second display mode upon switching from the second display mode to the third display mode, the processor switches, to an active window, a window displayed on the top layer of the first screen area in the second display mode.

The above information processing apparatus may be such that, in the display control processing, when the display is controlled by splitting the screen area of the display into two display areas in the second display mode, the processor splits the first screen area into two display areas to display, in one display area of the two display areas, a window displayed in the first screen area in the second display mode, and display, in the other display area, a window displayed in a display area other than the first screen area in response to switching from the second display mode to the third display mode.

Further, an information processing apparatus according to the third aspect of the present invention includes: a memory which temporarily stores a program of an application; a display; and a processor which executes the program of the application stored in the memory to perform control to display a window of the application on the display, wherein the processor performs mounting detection processing to detect the mounting of an external keyboard on a predetermined screen area within a screen area of the display, and display control processing to control switching among a first display mode in which display is controlled using the entire screen area of the display as one display area, a second display mode in which the display is controlled by splitting the screen area of the display into two display areas of a first screen area that does not contain the predetermined screen area and a second screen area that contains the predetermined screen area, and a third display mode in which, when the mounting of the keyboard is detected by the mounting detection processing, the display is controlled using, as a display area, only the first screen area of the first screen area and the second screen area, and in the display control processing, the processor splits the first screen area into two display areas in response to switching from the second display mode to the third display mode to display, in one display area of the two display areas, a window displayed in the first screen area in the second display mode, and display, in the other display area, a window displayed in the second screen area.

The above information processing apparatus may be such that, when the display mode is controlled to the third display mode by the display control processing, the processor controls a display area that contains at least the predetermined screen area to black display or display off.

The above information processing apparatus may also be such that the display is foldable one display.

The above information processing apparatus may further be such that the display includes two or more displays.

Further, a control method for an information processing apparatus according to the fourth aspect of the present invention is a control method for an information processing apparatus including: a memory which temporarily stores a program of an application; a display; and a processor which executes the program of the application stored in the memory to perform control to display a window of the application on the display, the control method including: a mounting detection step of causing the processor to detect the mounting of an external keyboard on a predetermined screen area within a screen area of the display; and a display control step of causing the processor to control switching among a first display mode in which display is controlled using the entire screen area of the display as one display area, a second display mode in which the display is controlled by splitting the screen area of the display into two or more display areas, and a third display mode in which, when the mounting of the keyboard is detected by the mounting detection step, the display is controlled using, as a display area, a first screen area as part of the screen area of the display except the predetermined screen area, wherein in the display control step, when switching from the second display mode to the third display mode, the processor arranges or minimizes, in the first screen area, a window displayed in a display area other than the first screen area in the second display mode, and when arranging the window in the first screen area, the processor arranges the window on a layer lower than a window displayed on the top layer of the first screen area in the second display mode.

Further, a control method for an information processing apparatus according to the fifth aspect of the present invention is a control method for an information processing apparatus including: a memory which temporarily stores a program of an application; a display; and a processor which executes the program of the application stored in the memory to perform control to display a window of the application on the display, the control method including: a mounting detection step of causing the processor to detect the mounting of an external keyboard on a predetermined screen area within a screen area of the display; and a display control step of causing the processor to control switching among a first display mode in which display is controlled using the entire screen area of the display as one display area, a second display mode in which the display is controlled by splitting the screen area of the display into two or more display areas, and a third display mode in which, when the mounting of the keyboard is detected by the mounting detection step, the display is controlled using, as a display area, a first screen area as part of the screen area of the display except the predetermined screen area, wherein in the display control step, when an active window is displayed in a display area other than the first screen area in the second display mode upon switching from the second display mode to the third display mode, the processor switches, to an active window, a window displayed on the top layer of the first screen area in the second display mode.

Further, a control method for an information processing apparatus according to the sixth aspect of the present invention is a control method for an information processing apparatus including: a memory which temporarily stores a program of an application; a display; and a processor which executes the program of the application stored in the memory to perform control to display a window of the application on the display, the control method including: a mounting detection step of causing the processor to detect the mounting of an external keyboard on a predetermined screen area within a screen area of the display; and a display control step of causing the processor to control switching among a first display mode in which display is controlled using the entire screen area of the display as one display area, a second display mode in which the display is controlled by splitting the screen area of the display into two display areas of a first screen area that does not contain the predetermined screen area and a second screen area that contains the predetermined screen area, and a third display mode in which, when the mounting of the keyboard is detected by the mounting detection step, the display is controlled using, as a display area, only the first screen area of the first screen area and the second screen area, wherein in the display control step, the processor splits the first screen area into two display areas in response to switching from the second display mode to the third display mode to display, in one display area of the two display areas, a window displayed in the first screen area in the second display mode, and display, in the other display area, a window displayed in the second screen area.

The above-described aspects of the present invention can control display properly when controlling the display by splitting the screen area of a display screen into two or more areas.

### BRIEF DESCRIPTION OF THE DRAWINGS

FIG. 1 is a perspective view illustrating the appearance of an information processing apparatus according to one or more embodiments.

FIG. 2 is a side view illustrating an example of the information processing apparatus in a bent state according to one or more embodiments.

FIG. 3 is a side view illustrating an example of the information processing apparatus in a flat state according to one or more embodiments.

FIG. 4 is a diagram illustrating specific examples of various display modes of the information processing apparatus according to one or more embodiments.

FIGS. 5A-5C are diagrams illustrating an example of operation specifications of display mode switching operations according to one or more embodiments.

FIG. 6 is a diagram illustrating an example of control from a one-screen mode to a half-screen mode according to one or more embodiments.

FIG. 7 is a diagram illustrating an example of control from a two-screen mode to the half-screen mode according to one or more embodiments.

FIG. 8 is a block diagram illustrating a hardware configuration example of the information processing apparatus according to one or more embodiments.

FIG. 9 is a block diagram illustrating a functional configuration example related to display control processing according to one or more embodiments.

FIG. 10 is a flowchart illustrating an example of half-screen mode switching processing according to one or more embodiments.

FIG. 11 is a diagram illustrating an example of operation specifications of display mode switching operations according to one or more embodiments.

FIG. 12 is a diagram illustrating a first example of control from a three-screen mode to the half-screen mode according to one or more embodiments.

FIG. 13 is a diagram illustrating a second example of control from the three-screen mode to the half-screen mode according to one or more embodiments.

FIG. 14 is a diagram illustrating an example of control from a four-screen mode to the half-screen mode according to one or more embodiments.

FIG. 15 is a diagram illustrating an example of control from the two-screen mode to the half-screen mode according to one or more embodiments.

FIG. 16 is a flowchart illustrating a first example of half-screen mode switching processing according to one or more embodiments.

FIG. 17 is a flowchart illustrating a second example of half-screen mode switching processing according to one or more embodiments.

### DETAILED DESCRIPTION

Embodiments of the present invention will be described below with reference to the accompanying drawings.

### First Embodiment

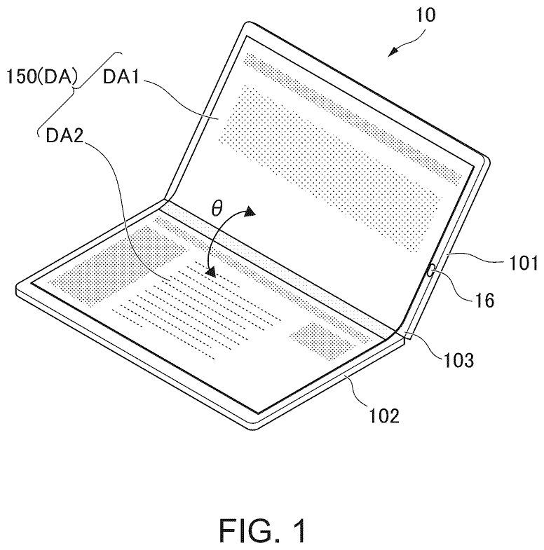

FIG. 1 is a perspective view illustrating the appearance of an information processing apparatus 10 according to one or more embodiments. The information processing apparatus 10 according to one or more embodiments is a clamshell (laptop) PC (Personal Computer). The information processing apparatus 10 includes a first chassis 101, a second chassis 102, and a hinge mechanism 103. The first chassis 101 and the second chassis 102 are chassis having a substantially rectangular plate shape (for example, a flat plate shape). One of the sides of the first chassis 101 and one of the sides of the second chassis 102 are joined (coupled) through the hinge mechanism 103 in such a manner that the first chassis 101 and the second chassis 102 are rotatable relative to each other around the rotation axis of the hinge mechanism 103. A state where an open angle between the first chassis 101 and the second chassis 102 around the rotation axis is substantially 0° is a state where the first chassis 101 and the second chassis 102 overlap each other and are closed. The state where the first chassis 101 and the second chassis 102 are closed is called a “closed state.” Surfaces of the first chassis 101 and the second chassis 102 on the sides to face each other in the closed state are called “inner surfaces,” respectively, and surfaces on the other sides of the inner surfaces are called “outer surfaces.” The open angle θ can also be called an angle between the inner surface of the first chassis 101 and the inner surface of the second chassis 102. A state opposite to the closed state, where the first chassis 101 and the second chassis 102 are open, is called an “open state.” The open state is a state where the first chassis 101 and the second chassis 102 are rotated relative to each other until the open angle θ exceeds a preset threshold value (for example, 10°).

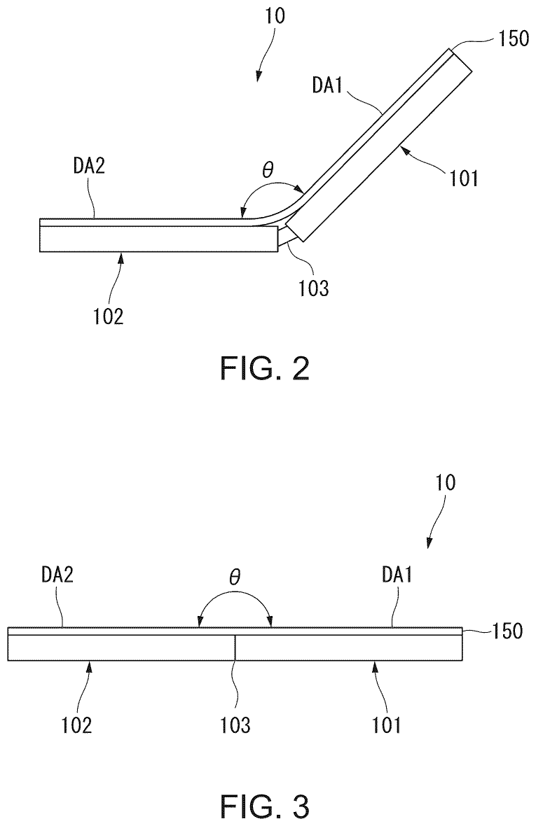

Further, the information processing apparatus 10 includes a camera 16 and a display 150. The camera 16 is provided on the inner surface of the first chassis 101. The display 150 is provided from the inner surface of the first chassis 101 to the inner surface of the second chassis 102. The camera 16 is provided, for example, in an outer part of a screen area DA of the display 150 on the inner surface of the first chassis 101 to be able to image a user and the like present on the side facing the display 150. The display 150 is a flexible display bendable to fit the open angle θ by relative rotation of the first chassis 101 and the second chassis 102 (see FIG. 2 and FIG. 3). As the flexible display, an organic EL display or the like is used. The information processing apparatus 10 can control not only the display as a one-screen structure in which the entire screen area DA of the display 150 is used as one display area, but also the display as a two-screen structure in which the screen area DA of the display 150 is split into two display areas of a first screen area DAL and a second screen area DA2. Since the two display areas are obtained by splitting the screen area DA into the first screen area DAL and the second screen area DA2, these are display areas that do not overlap each other. Here, it is assumed that a screen area corresponding to the inner surface side of the first chassis 101 in the screen area DA of the display 150 is the first screen area DA1, and a screen area corresponding to the inner surface side of the second chassis 102 is the second screen area DA2. In the following, a display mode to control the display in the one-screen structure is called a “one-screen mode,” and a display mode to control the display in the two-screen structure is called a “two-screen mode.”

Note that a touch sensor is provided on (the surface of) the screen area DA of the display 150. The information processing apparatus 10 can detect touch operations on the screen area DA of the display 150. A user can visually recognize the display areas of the display 150 provided on the respective inner surfaces of the first chassis 101 and the second chassis 102 and perform touch operations on the display 150 by putting the information processing apparatus 10 into the open state, thus enabling the use of the information processing apparatus 10.

Next, usage forms and screen modes of the information processing apparatus 10 will be described in detail. First, the usage forms of the information processing apparatus 10 are classified by the open angle θ between the first chassis 101 and the second chassis 102 into a bent state in which the first chassis 101 and the second chassis 102 are bent (Bent form), and a flat state in which the first chassis 101 and the second chassis 102 are not bent (Flat form). In the following, the state where the first chassis 101 and the second chassis 102 are bent (Bent form) is simply called the “bent state (Bent form),” and the flat state where the first chassis 101 and the second chassis 102 are not bent (Flat form) is simply called the “flat state (Flat form).” In the bent state (Bent form), the display 150 provided over the first chassis 101 and the second chassis 102 is also in the bent state. In the flat state (Flat form), the display 150 is also in the flat state.

FIG. 2 is a side view illustrating an example of the information processing apparatus 10 in the bent state (Bent form). The display 150 is placed over (across the border between) the first chassis 101 and the second chassis 102. The screen area of the display 150 (the screen area DA illustrated in FIG. 1) can be bent using a part corresponding to the hinge mechanism 103 as a crease, and on the border of this crease, a screen area on the side of the first chassis 101 is illustrated as the first screen area DA1, and a screen area on the side of the second chassis 102 is illustrated as the second screen area DA2. The display 150 is bent according to the rotation of (the open angle θ between) the first chassis 101 and the second chassis 102. The information processing apparatus 10 determines whether or not the state is the bent state (Bent form) according to the open angle θ. As an example, in the case of 10°<θ<170°, the information processing apparatus 10 determines that the state is the bent state (Bent form). This state corresponds to a usage form as a so-called clamshell mode or a book mode.

FIG. 3 is a side view illustrating an example of the information processing apparatus 10 in the flat state (Flat form). The information processing apparatus 10 typically determines that the state is the flat state (Flat form) when the open angle θ is 180°, but as an example, the information processing apparatus 10 may also determine that the state is the flat state (Flat form) when the open angle θ is in a range of 170°≤θ≤180°. For example, when the open angle θ between the first chassis 101 and the second chassis 102 is 180°, the display 150 is also in the flat state. This state corresponds to a usage form as a so-called tablet mode.

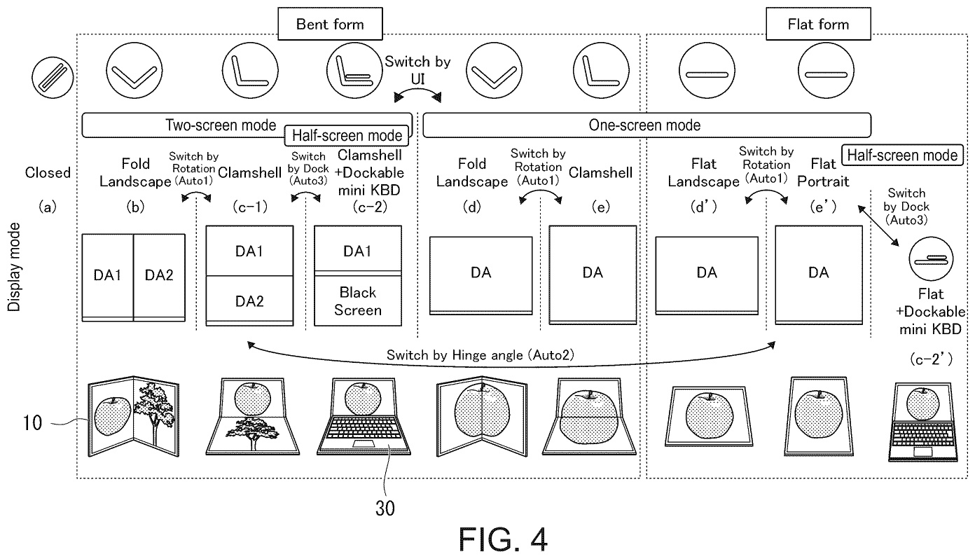

Referring next to FIG. 4, display modes by various usage forms of the information processing apparatus 10 will be described in detail.

FIG. 4 is a diagram illustrating specific examples of various display modes of the information processing apparatus 10 according to one or more embodiments. The display mode of the information processing apparatus 10 varies depending on the usage form classified by the open angle θ between the first chassis 101 and the second chassis 102, the posture (orientation) of the information processing apparatus 10, whether the mode is the one-screen mode or the two-screen mode, and the like. Note that one screen is also called a single screen, and two screens are also called spilt screens or dual screens.

Display mode (a) is a display mode when the first chassis 101 and the second chassis 102 are in the closed state (Closed) as the usage form. For example, in this closed state, the information processing apparatus 10 is in a standby state such as a sleep or hibernation state, and the display 150 is in a display-off state. This standby state such as the sleep or hibernation state corresponds, for example, to S3 or S4 as system power status defined in the ACPI (Advanced Configuration and Power Interface) specification.

Display mode (b) is a display mode in the bent state (Bent form) as the usage form and in the two-screen mode in which the display is controlled by splitting the screen area DA of the display 150 into the two screen areas of the first screen area DA1 and the second screen area DA2. Further, the orientation of the information processing apparatus 10 is an orientation in which the first screen area DA1 and the second screen area DA2 are lined up side by side in portrait orientation. The portrait orientation of the screen areas means an orientation in which long sides of the four sides of each of rectangular screen areas DA1 and DA2 are vertical and short sides are horizontal. When the display areas are in portrait orientation, the display orientation is also portrait orientation, and the display is provided in such an orientation that the direction along the long sides corresponds to the up-down direction and the direction along the short sides corresponds to the left-right direction. This usage form is a usage form in which left and right screens correspond to left and right pages when a book is opened, which corresponds to the so-called book mode. Since this usage form is the bent state (Bent form) and the display area obtained by combining the two screen areas of the first screen area DA1 and the second screen area DA2 lined up side by side is horizontally long, it is also called “Fold Landscape.”

In this display mode (b), the information processing apparatus 10 is in a two-screen display mode in which the first screen area DA1 on the left side is a primary screen and the second screen area DA2 on the right side is a secondary screen, for example, in the normal operating state. Note that the correspondence relationship of the first screen area DA1 and the second screen area DA2 with the primary screen and the secondary screen in the display mode (b) may be reversed.

Like the display mode (b), display mode (c-1) is a display mode in the bent state (Bent form) and in the two-screen mode in which the display is controlled by splitting the screen area DA of the display 150 into the two display areas of the first screen area DAL and the second screen area DA2, but the display mode (c-1) is a usage form different from the display mode (b) in terms of the orientation of the information processing apparatus 10. The orientation of the information processing apparatus 10 is an orientation in which the first screen area DA1 and the second screen area DA2 are vertically lined up and down in landscape orientation. The landscape orientation of the screen areas means an orientation in which long sides of the four sides of each of the rectangular screen areas DAL and DA2 are horizontal and short sides are vertical. When the screen areas are in landscape orientation, the display orientation is also landscape, and the display is provided in such an orientation that the direction along the short sides corresponds to the up-down direction and the direction along the long sides corresponds to the left-right direction. This usage form is one of typical usage forms of a clamshell PC.

In this display mode (c-1), the information processing apparatus 10 is in the two-screen display mode in which the first screen area DA1 is the primary screen and the second screen area DA2 is the secondary screen, for example, in the normal operating state. Note that the correspondence relationship of the first screen area DAL and the second screen area DA2 with the primary screen and the secondary screen in the display mode (c-1) may be reversed.

For example, the information processing apparatus 10 detects a change in the posture (orientation) of the information processing apparatus 10 to automatically switch from the display mode (b) to the display mode (c-1) or from the display mode (c-1) to the display mode (b) (Switch by Rotation). For example, since the display mode (c-1) is in such a state that the display 150 is rotated 90 degrees to the right from the state of the display mode (b) in FIG. 4, the information processing apparatus 10 switches to the display mode (c-1) when detecting the rotation of a predetermined angle (for example, 45 degrees) or more to the right from the state of the display mode (b). Further, since the display mode (b) is in such a state that the display 150 is rotated 90 degrees to the left from the state of the display mode (c-1) in FIG. 4, the information processing apparatus 10 switches to the display mode (b) when detecting the rotation of a predetermined angle (for example, 45 degrees) or more to the left from the state of the display mode (c-1).

Like the display mode (c-1), display mode (c-2) is in the bent state (Bent form) and the orientation of the information processing apparatus 10 is the same, but it is different in that an external keyboard 30 (Dockable mini KBD (Keyboard)) connectable to the information processing apparatus 10 is connected. This usage form is in such a state that a physical keyboard 30 is connected in a general usage form of the clamshell PC. For example, the size of the keyboard 30 is almost equivalent to the size of the second screen area DA2, and the keyboard 30 is configured to be mountable on the second screen area DA2. As an example, magnets are provided inside the bottom (on the bottom edges) of the keyboard 30, and when the keyboard 30 is mounted on the second screen area DA2, the magnets are attracted to metal parts of the inner surface edges of the second chassis 102 and fixed. Thus, the usage form becomes a usage form similar to that of a traditional clamshell PC with a physical keyboard originally provided thereon. Further, when the keyboard 30 is mounted on the second screen area DA2, the mounted keyboard 30 and the information processing apparatus 10 are communicatively connected, for example, through Bluetooth (registered trademark). In this display mode (c-2), since the keyboard makes the second screen area DA2 invisible, the information processing apparatus 10 controls the second screen area DA2 to black display or display off. In other words, this display mode (c-2) is a display mode in which only half of the screen area DA is enabled to provide a display (hereinafter called a “half-screen mode”), which corresponds to a one-screen mode in which only the first screen area DA1 is targeted for display.

For example, when detecting the connection with the external keyboard in the state of the display mode (c-1), the information processing apparatus 10 automatically switches from the display mode (c-1) to the display mode (c-2) (Switch by Dock).

Like the display mode (b), display mode (d) is in the bent state (Bent form) and the orientation of the information processing apparatus 10 is the same, but it is different in that the display mode (d) is the one-screen mode in which the display of the entire screen area DA of the display 150 is controlled as one display area. Although this usage form is different from the display mode (b) in that the display mode is the one-screen mode, since it is in the bent state (Bent form) and the screen area DA is horizontally long, this usage form is also called “Fold Landscape.” The screen area DA is in landscape orientation and the display orientation is also landscape orientation.

Here, switching between the one-screen mode and the two-screen mode in the bent state (Bent form) is performed, for example, with a user operation. For example, the information processing apparatus 10 displays an operating element as a UI (User Interface) capable of switching between the one-screen mode and the two-screen mode somewhere on the screen to switch from the display mode (b) to the display mode (d) based on an operation on the operating element (Switch by UI). Specific examples of display mode switching operations will be described later.

Like the display mode (c-1), display mode (e) is in the bent state (Bent form) and the orientation of the information processing apparatus 10 is the same, but it is different in that the display mode (e) is in the one-screen mode in which the display of the entire screen area DA of the display 150 is controlled as one display area. This usage form is different from the display mode (c-1) in that the display mode (e) is the one-screen mode, but the display mode (e) corresponds to a usage form of the clamshell PC from the bent state (Bent form) and the orientation of the information processing apparatus 10. The screen area DA is in portrait orientation and the display orientation is also portrait orientation.

For example, the information processing apparatus 10 detects a change in the posture (orientation) of the information processing apparatus 10 to automatically switch from the display mode (d) to the display mode (e), or from the display mode (e) to the display mode (d) (Switch by Rotation). For example, since the display mode (e) is in such a state that the display 150 is rotated 90 degrees to the right from the state of the display mode (d) in FIG. 4, the information processing apparatus 10 switches to the display mode (e) when detecting the rotation of a predetermined angle (for example, 45 degrees) or more to the right from the state of the display mode (d). Further, since the display mode (d) is in such a state that the display 150 is rotated 90 degrees to the left from the state of the display mode (e) in FIG. 4, the information processing apparatus 10 switches to the display mode (d) when detecting the rotation of a predetermined angle (for example, 45 degrees) or more to the left from the state of the display mode (e).

Like the display mode (d), display mode (d′) is the one-screen mode and the orientation of the information processing apparatus 10 is such an orientation that the screen area DA is horizontally long, but it is different in that the information processing apparatus 10 is in the flat state (Flat form). The flat state (Flat form) is a state in which the open angle θ between the first chassis 101 and the second chassis 102 is substantially 180°. This usage form corresponds to the so-called tablet mode described with reference to FIG. 3. Since this usage form is in the flat state (Flat form) and the screen area DA is horizontally long, it is also called “Flat Landscape.” This display mode (d′) is different from the display mode (d) only in the open angle θ between the first chassis 101 and the second chassis 102. Like in the display mode (d), the screen area DA in the display mode (d′) is in landscape orientation and the display orientation is also landscape orientation.

Like the display mode (e), display mode (e′) is the one-screen mode and the orientation of the information processing apparatus 10 is such an orientation that the screen area DA is vertically long, but it is different in that the information processing apparatus 10 is in the flat state (Flat form). Since this usage form is in the flat state (Flat form) and the screen area DA is vertically long, it is also called “Flat Portrait.” This display mode (e′) is different from the display mode (e) only in the open angle θ between the first chassis 101 and the second chassis 102. Like in the display mode (e), the screen area DA in the display mode (e′) is in portrait orientation and the display orientation is also portrait orientation.

For example, the information processing apparatus 10 detects a change in the posture (orientation) of the information processing apparatus 10 to automatically switch from the display mode (d′) to the display mode (e′), or from the display mode (e′) to the display mode (d′) (Switch by Rotation). For example, since the display mode (e′) is in such a state that the display 150 is rotated 90 degrees to the right from the state of the display mode (d′) in FIG. 4, the information processing apparatus 10 switches to the display mode (e′) when detecting the rotation of a predetermined angle (for example, 45 degrees) or more to the right from the state of the display mode (d′). Further, since the display mode (d′) is in such a state that the display 150 is rotated 90 degrees to the left from the state of the display mode (e′) in FIG. 4, the information processing apparatus 10 switches to the display mode (d′) when detecting the rotation of a predetermined angle (for example, 45 degrees) or more to the left from the state of the display mode (e′).

Note that in the display mode (d′) and the display mode (e′), it is also possible to switch to the two-screen mode while keeping the flat state (Flat form) by the user performing an operation on a display mode switching icon. For example, when switching to the two-screen mode from the state of the display mode (d′), the display state becomes similar to the display mode (b) in the flat state (Flat form). Further, when switching to the two-screen mode from the state of the display mode (e′), the display state becomes similar to the display mode (c-1) in the flat state (Flat form).

Further, when detecting the connection with the keyboard 30 in the state of the display mode (e′), the information processing apparatus 10 automatically switches from the display mode (e′) to display mode (c-2′) (Switch by Dock). The display mode (c-2′) is in the flat state (Flat form) but different from the display mode (c-2) only in the open angle θ between the first chassis 101 and the second chassis 102. In this display mode (c-2′), since the second screen area DA2 becomes invisible by the keyboard, the information processing apparatus 10 controls the second screen area DA2 to black display or display off. In other words, like the display mode (c-2), this display mode (c-2′) is the half-screen mode in which only the first screen area DA1 is targeted for display.

Further, when detecting a change from the flat state (Flat form) to the bent state (Bent form), the information processing apparatus 10 can also switch from the one-screen mode to the two-screen mode. For example, when detecting a change to the bent state (Bent form) in the state of the display mode (d′) based on the open angle θ between the first chassis 101 and the second chassis 102, the information processing apparatus 10 automatically switches from the display mode (d′) to the display mode (b). Further, when detecting a change to the bent state (Bent form) in the state of the display mode (e′) based on the open angle θ between the first chassis 101 and the second chassis 102, the information processing apparatus 10 automatically switches from the display mode (e′) to the display mode (c-1).

### (Display Mode Switching Operations)

Next, specific examples of operation specifications when switching between display modes by user operations will be described.

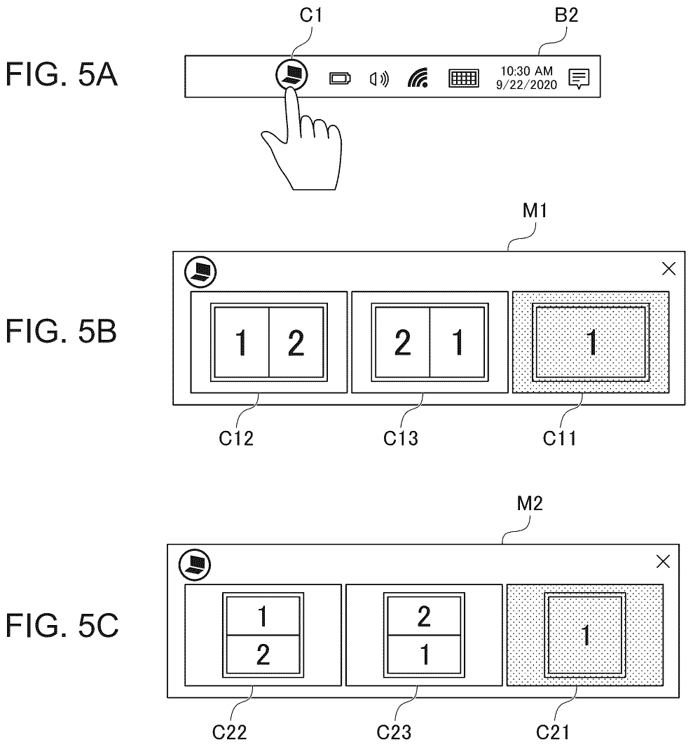

FIGS. 5A-5C are diagrams illustrating an example of operation specifications of display mode switching operations according to one or more embodiments. For example, as illustrated in FIG. 5A, an icon C1 to display a display mode switching menu is displayed on a task bar B2. The task bar B2 is displayed somewhere in the screen area DA of the display 150. For example, the task bar B2 is displayed only in one place within the screen area DA of the display 150 (for example, at the bottom of the screen area DA) regardless of the one-screen mode or the two-screen mode. Note that in the case of the two-screen mode, the task bar B2 may also be displayed respectively in the first screen area DA1 and the second screen area DA2 (for example, at the bottom of the respective screen areas).

When an operation is performed on the icon C1 to display the switching menu, the display mode switching menu is displayed as a pop-up screen. Note that the display mode switching menu may also be displayed as the pop-up screen when the state of the information processing apparatus 10 changes from the bent state (Bent form) to the flat state (Flat form) in which the information processing apparatus 10 is not bent. Further, the display mode switching menu may be displayed as the pop-up screen when the state of the information processing apparatus 10 changes from the flat state (Flat form) to the bent state (Bent form).

On the switching menu, display mode switching icons for allowing the user to give instructions to switch between the one-screen mode and the two-screen mode and to replace display data to be displayed respectively in the first screen area DA1 and the second screen area DA2 (for example, to replace the primary screen and the secondary screen) are displayed as display mode options. On the switching menu, the display mode options selectable by the user depending on the usage form (the orientation of the display 150) at the time are displayed.

FIG. 5B illustrates a switching menu M1 displayed when the usage form is “Landscape” (the display mode (b), the display mode (d), the display mode (d′), or the like). Note that “1” and “2” in FIG. 5B are affixed to distinguish between the display areas in the two-screen mode, and “1” and “2” are called the display area “1” and the display area “2” below. On the switching menu M1, a display mode switching icon C11, a display mode switching icon C12, and a display mode switching icon C13 are displayed. The display mode switching icon C11 is displayed as an operating element for selecting the display mode (d) or the display mode (d′) as the one-screen mode. The display mode switching icon C12 and the display mode switching icon C13 are displayed as operating elements for selecting the display mode (b) as the two-screen mode, where the display mode switching icon C12 and the display mode switching icon C13 are different in the order of the display area “1” and the display area “2.”

Note that a display mode switching icon corresponding to the current display mode is displayed in a display form distinguishable from the other display mode switching icons. Here, the display mode switching icon C11 is highlighted to distinguish from the other display mode switching icons C12 and C13 to make it clear that the display mode is the current display mode.

FIG. 5C illustrates a switching menu M2 displayed when the usage form is “Clamshell” (the display mode (c-1), the display mode (e), the display mode (e′), or the like). On the switching menu M2, a display mode switching icon C21, a display mode switching icon C22, and a display mode switching icon C23 are displayed. The display mode switching icon C21 is displayed as an operating element for selecting the display mode (e) or the display mode (e′) as the one-screen mode. The display mode switching icon C22 and the display mode switching icon C23 are displayed as operating elements for selecting the display mode (c-1) as the two-screen mode, where the display mode switching icon C22 and the display mode switching icon C23 are different in the order of the display area “1” and the display area “2.”

Note that, like the switching menu M1 illustrated in FIG. 5B, a display mode switching icon corresponding to the current display mode is displayed on the switching menu M2 in a display form distinguishable from the other display mode switching icons. Here, the display mode switching icon C21 is highlighted to distinguish from the other display mode switching icons C22 and C23 to make it clear that the display mode switching icon C21 is the current display mode.

The user can select any of the display mode switching icons displayed on the switching menu M1 or the switching menu M2 arbitrarily. When the user selects any one of the display mode switching icons, the display of the switching menu is ended. Otherwise, when the user selects none of the display mode switching icons even after a predetermined time (for example, three to five seconds) has passed since the switching menu M1 or the switching menu M2 was displayed, the display of the switching menu is ended. Further, when the user presses a close button “x” at the top right of the switching menu, when the user performs an operation outside of the screen of the switching menu being popped up, or when the orientation of the information processing apparatus 10 is changed, the display of the switching menu is ended. Note that in the state where the keyboard 30 is connected, since only the first screen area DA1 is fixed to the half-screen mode (display mode (c-2)) targeted for display, the switching menu is not displayed.

Note that the UI for switching between the one-screen mode and the two-screen mode is not limited to the example illustrated in FIGS. 5A-5C, and any other UI can be used. For example, an icon that alternately switches between the one-screen mode and the two-screen mode each time the icon is operated, or an icon that switches among the one-screen mode, the two-screen mode, and the reversed two-screen mode in order each time the icon is operated may be displayed on the task bar B2.

Further, in the example illustrated in FIGS. 5A-5C, the display mode switching menu is displayed as a pop-up screen with an operation on the icon C1 displayed on the task bar B2, but the switching menu may also be displayed as a pop-up screen with a drag operation on an application window or the like. Further, the display mode may be switched with the drag operation on the application window or the like. When the switching menu is popped up with the drag operation on the application window, the application window may be dragged into one of split areas of a screen area displayed on the switching menu to make not only a screen mode but also a screen area selectable and to arrange the dragged application in the selected area. Further, the switching menu may be displayed as a pop-up screen with an operation on a specific location of the application window.

### (Display Control of Half-Screen Mode)

Next, control when the information processing apparatus 10 transitions to the half-screen mode in response to the fact that the keyboard 30 is mounted will be described. Note that the keyboard 30 can be connected by being mounted only on the second screen area DA2 on the side of the second chassis 102 without the camera 16 provided thereon. When the keyboard 30 is mounted on the second screen area DA2, the information processing apparatus 10 transitions to the half-screen mode. In the half-screen mode, the information processing apparatus 10 controls the display using only the first screen area DA1 as an effective display area, and controls the second screen area DA2 to black display or display off.

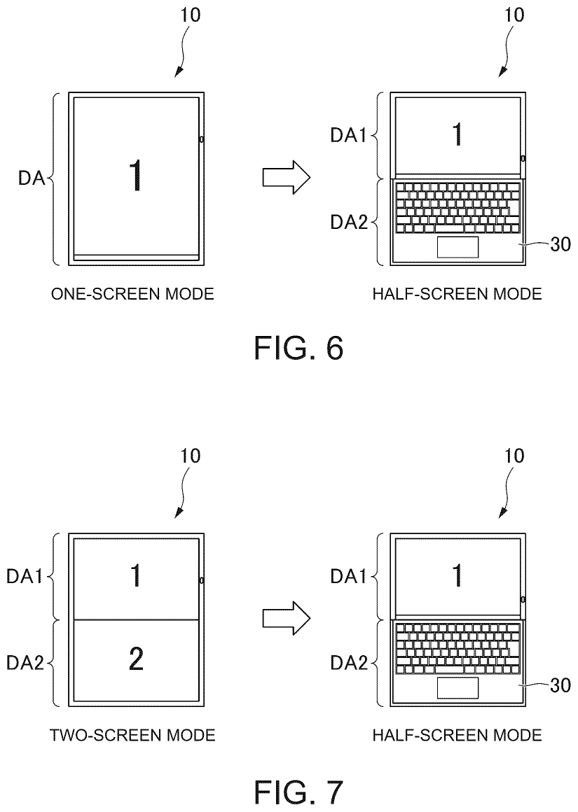

FIG. 6 is a diagram illustrating an example of control from the one-screen mode to the half-screen mode according to one or more embodiments. In the one-screen mode, the information processing apparatus 10 controls the display using the screen area DA as one display area “1,” and when transitioning to the half-screen mode, the information processing apparatus 10 controls the display by targeting only the first screen area DA1 for the display and reducing the display area “1” by half. At this time, the information processing apparatus 10 rearranges, in the first screen area DA1, a window of a running application (hereinafter simply called “window”) displayed in the screen area DA in the one-screen mode while maintaining the layer hierarchy. Further, the information processing apparatus 10 controls the second screen area DA2 with the keyboard 30 mounted thereon to black display or display off.

FIG. 7 is a diagram illustrating an example of control from the two-screen mode to the half-screen mode according to one or more embodiments. In the two-screen mode, the information processing apparatus 10 controls the display by splitting the screen area DA into two display areas of the first screen area DA1 and the second screen area DA2 (the display area “1” and the display area “2”). When transitioning to the half-screen mode, the information processing apparatus 10 targets only the first screen area DA1 (display area “1”) for display, and maintains a window displayed in the first screen area DA1 (the display area “1”) in the two-screen mode. Further, the information processing apparatus 10 arranges a window, displayed in the second screen area DA2 (display area “2”) in the two-screen mode, on a layer lower than a window displayed on the top layer in the first screen area DA1 (the display area “1”).

Further, when an active window is displayed in the second screen area DA2 (the display area “2”) in the two-screen mode, the information processing apparatus 10 may switch, to an active window, the window displayed on the top layer of the first screen area DA1 (the display area “1”) in the two-screen mode in response to switching to the half-screen mode. Note that, when an active window is displayed in the first screen area DA1 (the display area “1”) in the two-screen mode, the information processing apparatus 10 maintains the display of the active window even after switching to the half-screen mode. In other words, after switching to the half-screen mode, the information processing apparatus 10 may set, as an active window, the window displayed on the top layer of the first screen area DA1 (the display area “1”) regardless of in which of the first screen area DA1 (the display area “1”) and the second screen area DA2 (the display area “2”) the active window was displayed in the two-screen mode.

Note that, when the transition from the two-screen mode to the half-screen mode is made, the information processing apparatus 10 may minimize, in the first screen area DA1, a window displayed in the second screen area DA2 (the display area “2”) in the two-screen mode.

Thus, when the transition from the two-screen mode to the half-screen mode is made in response to the fact that the keyboard 30 is mounted, since the display state of windows (especially, the window on the top layer) of the first screen area DA1 (the display area “1”) on the side where the keyboard 30 is not mounted is maintained, the information processing apparatus 10 can prevent the user from feeling uncomfortable.

### (Hardware Configuration of Information Processing Apparatus 10)

A specific configuration of the information processing apparatus 10 will be described.

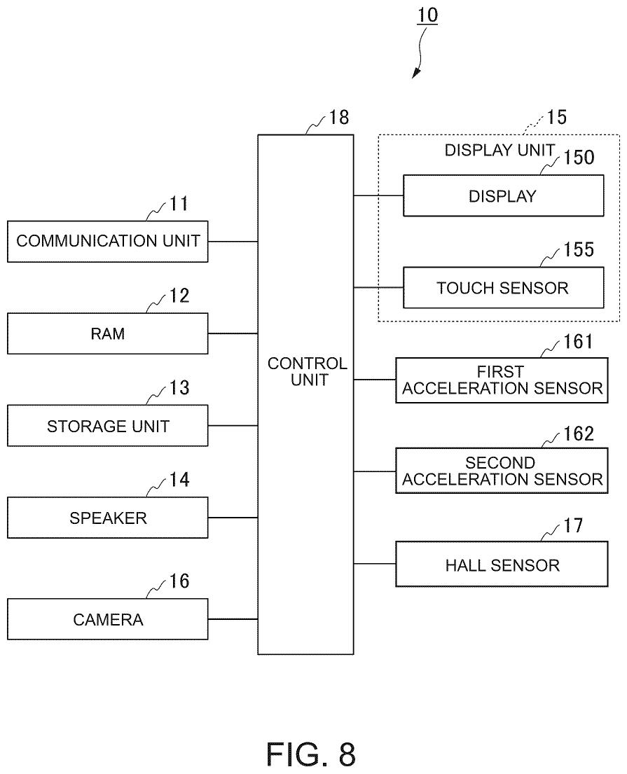

FIG. 8 is a block diagram illustrating an example of the hardware configuration of the information processing apparatus 10 according to one or more embodiments. The information processing apparatus 10 includes a communication unit 11, a RAM (Random Access Memory) 12, a storage unit 13, a speaker 14, the display unit 15, the camera 16, a first acceleration sensor 161, a second acceleration sensor 162, a Hall sensor 17, and a control unit 18. These units are communicably connected to one another through buses and the like.

The communication unit 11 is configured to include digital input/output ports such as two or more Ethernet (registered trademark) ports and two or more USB (Universal Serial Bus) ports, communication devices that perform wireless communication such as Bluetooth (registered trademark) and Wi-Fi (registered trademark), and the like. For example, the communication unit 11 can communicate with the above-described external keyboard 30 and the like using Bluetooth (registered trademark).

A program and data for processing executed by the control unit 18 are loaded into the RAM 12, and various data are stored or deleted appropriately. For example, the RAM 12 also functions as a video memory (V-RAM) for providing a display screen on the display 150. As an example, the RAM 12 functions as a video memory for data displayed in the screen area DA when the display 150 is controlled to the one-screen mode. Further, the RAM 12 functions as a video memory for data displayed in the first screen area DA1 and the second screen area DA2 when the display 150 is controlled to the two-screen mode. Further, in the RAM 12, information on running apps, an app in use among the running apps (an app in the active window), information on the other apps in inactive windows, information about in which screen area each window is displayed, and the like are stored. Note that since the RAM 12 is a volatile memory, no data is retained when power supply to the RAM 12 is stopped. Data that must be retained when the power supply to the RAM 12 is stopped is transferred to the storage unit 13.

The storage unit 13 is configured to include any one or more of an SSD (Solid State Drive), an HDD (Hard Disk Drive), a ROM (Read Only Memory), and a Flash ROM. For example, in the storage unit 13, a BIOS (Basic Input Output System) program and configuration data, an OS (Operating System), programs of apps running on the OS, various data used in the apps, and the like are stored.

The speaker 14 outputs electronic sound, voice, and the like.

The display unit 15 includes the display 150 and a touch sensor 155. As described above, the display 150 is a flexible display bendable to fit the open angle θ by relative rotation of the first chassis 101 and the second chassis 102. The display 150 provides a display screen corresponding to each display mode described with reference to FIG. 4 under the control of the control unit 18. The touch sensor 155 is provided on the screen of the display 150 to detect a touch operation on the screen. For example, in the case of the one-screen mode, the touch sensor 155 detects a touch operation in the screen area DA. Further, in the case of the two-screen mode, the touch sensor 155 detects a touch operation(s) in either or both of the first screen area DA1 and the second screen area DA2. A tap operation, a slide operation, a flick operation, a swipe operation, a pinch operation, and the like are included in touch operations. The touch sensor 155 detects a touch operation and outputs, to the control unit 18, operation information based on the detected operation.

The camera 16 is configured to include a lens, an image sensor, and the like. The camera 16 captures images (still images and moving images) and outputs data of captured images under the control of the control unit 18.

The first acceleration sensor 161 is provided inside the first chassis 101 to detect the orientation of the first chassis 101 and a change in the orientation of the first chassis 101. For example, assuming that a direction parallel to the long-side direction of the first screen area DA1 is X1 direction, a direction parallel to the short-side direction is Y1 direction, and a direction perpendicular to the X1 direction and the Y1 direction is Z1 direction, the first acceleration sensor 161 detects respective accelerations along the X1 direction, the Y1 direction, and the Z1 direction, and outputs the detection results to the control unit 18.

The second acceleration sensor 162 is provided inside the second chassis 102 to detect the orientation of the second chassis 102 and a change in the orientation of the second chassis 102. For example, assuming that a direction parallel to the long-side direction of the second screen area DA2 is X2 direction, a direction parallel to the short-side direction is Y2 direction, and a direction perpendicular to the X2 direction and the Y2 direction is Z2 direction, the second acceleration sensor 162 detects respective accelerations along the X2 direction, the Y2 direction, and the Z2 direction, and outputs the detection results to the control unit 18.

The Hall sensor 17 is provided to detect the connection of the keyboard 30. For example, when the keyboard 30 is mounted on the second screen area DA2 of the second chassis 102, the magnetic field changes by the approach of the magnets provided inside the bottom of the keyboard 30 to change a detection value (output value) of the Hall sensor 17. In other words, the Hall sensor 17 outputs a detection result different depending on whether or not the keyboard 30 is mounted. Note that it is detected whether or not the keyboard 30 is mounted by using the Hall sensor 17 here, but the detection method is not limited thereto, and any other detection method can be used.

The control unit 18 is configured to include processors such as a CPU (Central Processing Unit), a GPU (Graphic Processing Unit), and a microcomputer to realize various functions by executing programs (the BIOS, the OS, and various programs such as apps running on the OS) stored in the storage unit 13 and the like. For example, the control unit 18 detects the posture (orientation) of the information processing apparatus 10 based on the detection results of the first acceleration sensor 161 and the second acceleration sensor 162. Further, the control unit 18 detects whether the information processing apparatus 10 is in the open state or the closed state, whether the information processing apparatus 10 is in the bent state (Bent form) or the flat state (Flat form) in the case of the open state, and the like based on the detection results of the first acceleration sensor 161 and the second acceleration sensor 162.

Further, the control unit 18 detects a display mode switching operation by the user (for example, an operation on a display mode switching icon illustrated in FIGS. 5A-5C). Further, the control unit 18 detects the connection with the keyboard 30 based on the detection result of the Hall sensor 17. Note that this connection with the keyboard 30 indicates that the keyboard 30 is mounted on the second screen area DA2, and does not indicate communication connection. The control unit 18 detects the communication connection with the keyboard 30 using the function of Bluetooth (registered trademark) or the like.

Further, the control unit 18 detects the state of the system, the posture (orientation) of the information processing apparatus 10, whether the information processing apparatus 10 is in the open state or the closed state, and whether the information processing apparatus 10 is in the bent state (Bent form) or the flat state (Flat form) in the case of the open state, the display mode switching operation by the user, the connection with the keyboard 30, and the like to perform control for switching the display mode of the display 150 as described with reference to FIG. 4 and FIGS. 5A-5C, and display control when switching to the half-screen mode as described with reference to FIG. 6 and FIG. 7.

### (Functional Configuration of Information Processing Apparatus 10)

Next, a functional configuration related to display control processing among processing executed by the control unit 18 will be described.

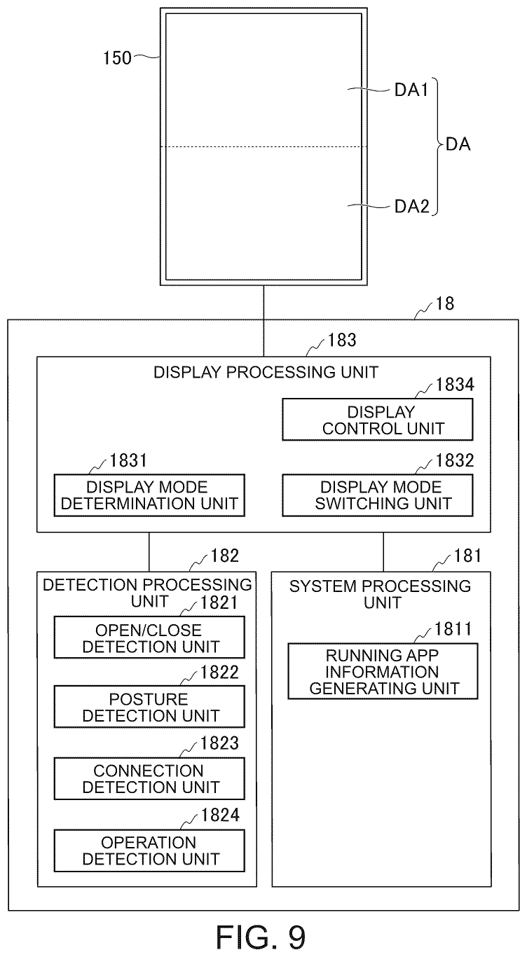

FIG. 9 is a block diagram illustrating an example of the functional configuration related to display control processing according to one or more embodiments. The control unit 18 includes a system processing unit 181, a detection processing unit 182, and a display processing unit 183. Here, the system processing unit 181 is a functional component in which the CPU executes processing based, for example, on the OS, the BIOS, or the like. Further, for example, the detection processing unit 182 is a functional component in which the microcomputer, different from the CPU that executes the processing of the OS or the BIOS, executes various detection processes. The display processing unit 183 is a functional component in which the CPU executes processing based, for example, on the OS or a program(s) running on the OS.

The system processing unit 181 executes the OS and various programs such as drivers and apps running on the OS. Further, for example, the system processing unit 181 includes a running app information generating unit 1811. The running app information generating unit 1811 generates app information including identification information on running apps (for example, app IDs), information indicative of an app in use by the user among the running apps, (that is, an app in the active window), and the like. The running app information generating unit 1811 stores and holds the generated app information and the like in the RAM 12.

The detection processing unit 182 includes, as functional components to detect the state of the information processing apparatus 10, an open/close detection unit 1821, a posture detection unit 1822, and a connection detection unit 1823. The detection processing unit 182 outputs, to the display processing unit 183, the detection results of the open/close detection unit 1821, the posture detection unit 1822, and the connection detection unit 1823.

The open/close detection unit 1821 detects whether the information processing apparatus 10 is in the open state or the closed state based on the detection results of the first acceleration sensor 161 and the second acceleration sensor 162. Further, when the information processing apparatus 10 is in the open state, the open/close detection unit 1821 detects the open angle θ between the first chassis 101 and the second chassis 102 based on the detection results of the first acceleration sensor 161 and the second acceleration sensor 162. Then, the open/close detection unit 1821 detects whether the information processing apparatus 10 is in the bent state (Bent form) or the flat state (Flat form) based on the detected open angle θ.

The posture detection unit 1822 detects the posture (orientation) of the information processing apparatus 10 based on the detection results of the first acceleration sensor 161 and the second acceleration sensor 162.

The connection detection unit 1823 performs connection detection processing to detect the connection with the keyboard 30. For example, the connection detection unit 1823 detects whether or not the keyboard 30 is mounted on the second screen area DA2 based on the detection result of the Hall sensor 17 to detect the connection with the keyboard 30. In other words, the connection detection processing to detect the connection with the keyboard 30 corresponds to mounting detection processing to detect whether or not the keyboard 30 is mounted on the second screen area DA2. In the state where the keyboard 30 is mounted on the second screen area DA2, the connection detection unit 1823 detects that the keyboard 30 is connected.

Further, the detection processing unit 182 includes an operation detection unit 1824 as a functional component to detect an operation on the information processing apparatus 10. The operation detection unit 1824 detects a user operation based on operation information output from the touch sensor 155 provided on the screen of the display 150. For example, the operation detection unit 1824 acquires operation information based on a user operation on the switching menu M1 or M2 (see FIGS. 5A-5C) capable of switching the display mode to detect a display mode switching operation to switch the display mode by the user based on the acquired operation information. The detection processing unit 182 outputs the detected user operation information to the display processing unit 183.

Based on the open/closed state and the posture (orientation) of the information processing apparatus 10, the user operation, and the like acquired from the detection processing unit 182, the display processing unit 183 determines a display mode and switches to the display mode. Further, based on the app information acquired from the system processing unit 181, the display processing unit 183 controls the display of windows of running apps (an active window and inactive windows) depending on the display mode. Specifically, the display processing unit 183 includes a display mode determination unit 1831, a display mode switching unit 1832, and a display control unit 1834.

The display mode determination unit 1831 performs determination processing to determine a display mode based on the detection result of the state of the information processing apparatus 10 or the user operation detected by the detection processing unit 182. For example, the display mode determination unit 1831 acquires, from the detection processing unit 182, the detection result of the open/closed state of the information processing apparatus 10, the detection result of whether the information processing apparatus 10 is in the bent state (Bent form) or the flat state (Flat form) in the case of the open state, the detection result of the posture (orientation) of the information processing apparatus 10, and the operation information based on the user operation on the switching menu M1 or M2 illustrated in FIGS. 5A-5C. Then, the display mode determination unit 1831 determines a display mode described with reference to FIG. 4 based on the respective detection results and the operation information acquired from the detection processing unit 182.

The display mode switching unit 1832 performs display mode switching processing to switch to a display mode as described with reference to FIG. 4 based on the display mode determined by the display mode determination unit 1831. For example, based on the display mode determined by the display mode determination unit 1831, the display mode switching unit 1832 switches between the one-screen mode and the two-screen mode (or the reversed two-screen mode), and sets a display mode such as the orientation of each screen area and the display content of each screen area.

Further, when the connection with the keyboard 30 is detected by the connection detection unit 1823, the display mode switching unit 1832 switches to the half-screen mode (see FIG. 6 and FIG. 7). As described above, the half-screen mode is a display mode in which the keyboard 30 is mounted on the second screen area DA2 and only the first screen area DA1 is targeted for display. Further, in the half-screen mode, the display mode switching unit 1832 controls the display to a preset display orientation regardless of the orientation of the display 150. For example, the present orientation of the display is an orientation in which the side of the first chassis 101 and the second chassis 102 being connected in the first screen area DA1 is the lower side (that is, the orientation in which the first screen area DA1 is on the upper side and the second screen area DA2 on which the keyboard 30 is mounted is on the lower side).

The display control unit 1834 controls the display screen of the display 150. For example, the display control unit 1834 performs control of on/off (providing/hiding) of the respective screen areas of the display 150, and outputs display data such as on a window of an app to be displayed in each screen area according to the display mode set by the display mode switching unit 1832 to provide a display. Further, when the transition from the standby state or a stopped state to the normal operating state is made, the display control unit 1834 controls the orientation of the display in the screen area of the display 150 in the normal operating state according to the orientation of the information processing apparatus 10 (the orientation of the screen area of the display 150).

Further, in the state where the connection with the keyboard 30 is detected by the connection detection unit 1823, when the orientation of the display in the screen area is changed according to the change in the orientation of the screen area of the display 150, the display control unit 1834 controls the display to the preset display orientation mentioned above after being changed.

Note that, in the state where the mounting of the keyboard 30 is detected by the connection detection unit 1823, the display control unit 1834 controls the display to the preset display orientation mentioned above without performing control to change the orientation of the display in the screen area according to the change in the orientation of the screen area of the display 150.

Here, display control when switching from the two-screen mode to the half-screen mode described with reference to FIG. 7 will be described. When switching from the two-screen mode to the half-screen mode, the display control unit 1834 arranges or minimizes, in the first screen area DA1, a window displayed in the display area “2” of the second screen area DA2 in the two-screen mode. Here, when arranging, in the first screen area DA1, the window displayed in the display area “2” of the second screen area DA2 in the two-screen mode, the display control unit 1834 arranges the window on a layer lower than the window displayed on the top layer of the first screen area DA1 in the two-screen mode.

Note that the display control unit 1834 may arrange the window, displayed in the display area “2” of the second screen area DA2 in the two-screen mode, on a layer one layer below the top layer of the first screen area DA1, or may arrange the window on a layer lower than all windows arranged in the first screen area DA1.

Further, when an active window is displayed in the display area “2” of the second screen area DA2 in the two-screen mode, the display control unit 1834 may switch the window, displayed on the top layer of the first screen area DA1 in the two-screen mode, to an active window in response to switching from the two-screen mode to the half-screen mode.

### (Half-Screen Mode Switching Processing)

Next, the operation of half-screen mode switching processing in which the control unit 18 switches from the one-screen mode or the two-screen mode to the half-screen mode will be described.

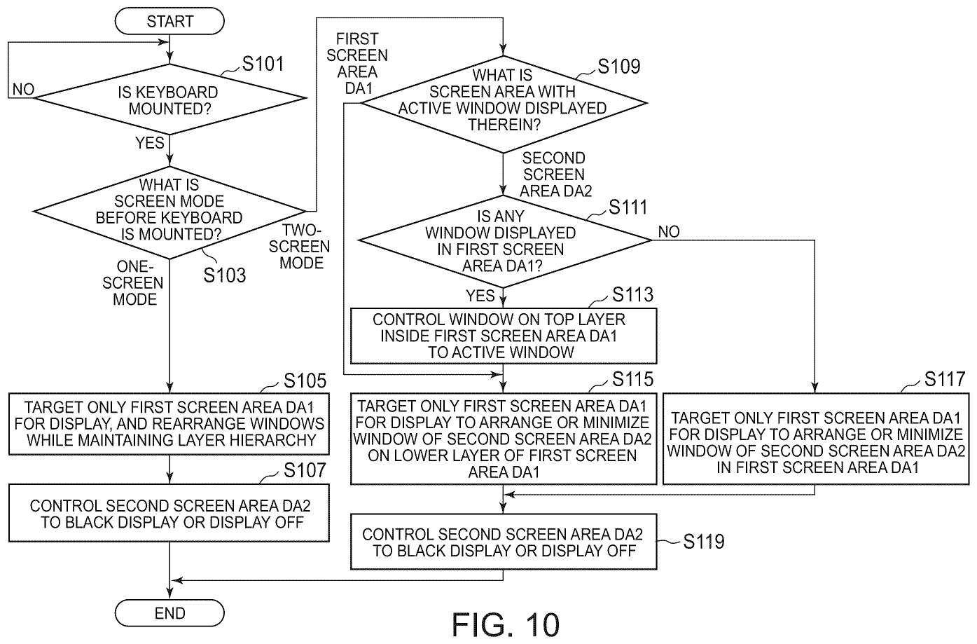

FIG. 10 is a flowchart illustrating an example of half-screen mode switching processing according to one or more embodiments.

(Step S101) The control unit 18 determines whether or not the keyboard 30 is mounted on the second screen area DA2 based on the detection result of the Hall sensor 17. When determining that the keyboard 30 is not mounted (NO), the control unit 18 performs the process in step S101 again. On the other hand, when determining that the keyboard 30 is mounted (YES), the control unit 18 proceeds to a process in step S103.

(Step S103) The control unit 18 determines a screen mode before the keyboard 30 is mounted. When determining that the screen mode before the keyboard 30 is mounted is the one-screen mode, the control unit 18 proceeds to a process in step S105. On the other hand, when determining that the screen mode before the keyboard 30 is mounted is the two-screen mode, the control unit 18 proceeds to a process in step S109.

(Step S105) The control unit 18 switches to the half-screen mode in which only the first screen area DA1 is targeted for display. For example, the control unit 18 rearranges, in the first screen area DA1, windows arranged in the screen area DA in the one-screen mode while maintaining the layer hierarchy. Then, the control unit 18 proceeds to a process in step S107.

(Step S107) The control unit 18 controls the second screen area DA2 to black display or display off, and ends the half-screen mode switching processing.

(Step S109) The control unit 18 determines a screen area in which an active window is displayed in the two-screen mode before the keyboard 30 is mounted. When the screen area in which the active window is displayed in the second screen area DA2, the control unit 18 proceeds to a process in step S111. On the other hand, when the screen area in which the active window is displayed is the first screen area DA1, the control unit 18 proceeds to a process in step S115.

(Step S111) When the active window is displayed in the second screen area DA2, the control unit 18 determines whether or not any window is displayed in the first screen area DA1. When determining that any window is displayed in the first screen area DA1 (YES), the control unit 18 proceeds to a process in step S113. On the other hand, when determining that no window is displayed in the first screen area DA1 (NO), the control unit 18 proceeds to a process in step S117.

(Step S113) The control unit 18 controls a window, arranged on the top layer inside the first screen area DA1, to an active window, and controls the active window displayed in the second screen area DA2 to an inactive window. Then, the control unit 18 proceeds to the process in step S115.

(Step S115) The control unit 18 switches to the half-screen mode in which only the first screen area DA1 is targeted for display. For example, the control unit 18 arranges or minimizes, on a lower layer of the first screen area DA1, a window arranged in the second screen area DA2. Then, the control unit 18 proceeds to a process in step S119.

(Step S117) When no window is displayed in the first screen area DA1, the control unit 18 switches to the half-screen mode in which only the first screen area DA1 is targeted for display, and arranges or minimizes, in the first screen area DA1, a window arranged in the second screen area DA2. Then, the control unit 18 proceeds to the process in step S119.

(Step S119) The control unit 18 controls the second screen area DA2 to black display or display off, and ends the half-screen mode switching processing.

As described above, the information processing apparatus 10 according to one or more embodiments includes: the RAM 12 (an example of a memory) which temporarily stores a program of an application, the display 150, and the control unit 18 (an example of a component including a processor) which executes the program of the application program stored in the RAM 12 to perform control to display a window of the application on the display 150. The control unit 18 performs mounting detection processing (connection detection processing) to detect the mounting (connection) of the external keyboard 30 on (to) the second screen area DA2 (an example of a predetermined screen area) within the screen area of the display 150. Further, the control unit 18 performs display control processing to control switching among the one-screen mode (an example of a first display mode) in which the display is controlled using the entire screen area DA of the display 150 as one display area, the two-screen mode (an example of a second display mode) in which the display is controlled by splitting the screen area DA of the display 150 into two or more display areas (for example, two display areas “1” and “2”), and the half-screen mode (an example of a third display mode) in which, when the mounting of the keyboard 30 is detected by the mounting detection processing, the display is controlled using, as a display area (for example, as the display area “1”), the first screen area DAL as part of the screen area DA of the display 150 except the second screen area DA2. Then, in the display control processing, when switching from the two-screen mode to the half-screen mode, the control unit 18 arranges or minimizes, in the first screen area DA1, a window displayed in a display area other than the first screen area DA1 (for example, in the display area “2” of the second screen area DA2) in the two-screen mode, and when arranging the window in the first screen area DA1, the control unit 18 arranges the window on a layer lower than a window displayed on the top layer of the first screen area DA1 in the two-screen mode.

Thus, when the transition from the two-screen mode to the half-screen mode is made by the fact that the keyboard 30 is mounted, since the display state of the window in the first screen area DA1 on the side where the keyboard 30 is not mounted is maintained, the information processing apparatus 10 can prevent the user from feeling uncomfortable. Therefore, the information processing apparatus 10 can control the display properly when controlling the display by splitting the screen area of the display 150 into two or more display areas.

Further, in the display control processing, when an active window is displayed in a display area other than the first screen area DA1 (for example, in the display area “2” of the second screen area DA2) in the two-screen mode, the control unit 18 switches, to an active window, the window displayed on the top layer of the first screen area DA1 in the two-screen mode in response to switching from the two-screen mode to the half-screen mode.

Thus, when the transition from two-screen mode to the half-screen mode is made by the fact that the keyboard 30 is mounted, since the window in the first screen area DAL on the side where the keyboard 30 is not mounted is maintained in such a display state that the window can be used preferentially, the information processing apparatus 10 can prevent the user from feeling uncomfortable. Therefore, the information processing apparatus 10 can control the display properly when controlling the display by splitting the screen area of the display 150 into two or more display areas.

Further, when performing control to the half-screen mode by the display control processing, the control unit 18 controls the second screen area DA2 (an example of a display area including at least the predetermined screen area) to black display or display off.

Thus, when performing control to the half-screen mode, the information processing apparatus 10 can set the screen area on which the external keyboard 30 is mounted as an area in which display is disabled.

Further, a control method for the information processing apparatus 10 according to one or more embodiments includes: a mounting detection step of causing the control unit 18 to detect mounting (connection) of the external keyboard 30 on the second screen area DA2 (the example of the predetermined screen area) within the screen area of the display 150; and display control step of causing the control unit 18 to control switching among the one-screen mode (the example of the first display mode) in which display is controlled using the entire screen area DA of the display 150 as one display area, the two-screen mode (the example of the second display mode) in which the display is controlled by splitting the screen area DA of the display 150 into two or more display areas (for example, two display areas “1” and “2”), and the half-screen mode (the example of the third display mode) in which, when the mounting of the keyboard 30 is detected by the mounting detection step, the display is controlled using, as a display area (for example, the display area “1”), the first screen area DAL as part of the screen area DA of the display 150 except the second screen area DA2. Then, in the display control strep, when switching from the two-screen mode to the half-screen mode, the control unit 18 arranges or minimizes, in the first screen area DA1, a window displayed in a display area other than the first screen area DA1 (for example, in the display area “2” of the second screen area DA2) in the two-screen mode, and when arranging the window in the first screen area DA1, the control unit 18 arranges the window on a layer lower than a window displayed on the top layer of the first screen area DA1 in the two-screen mode.

Thus, when the transition from the two-screen mode to the half-screen mode is made by the fact that the keyboard 30 is mounted, since the display state of the window in the first screen area DAL on the side where the keyboard 30 is not mounted is maintained, the information processing apparatus 10 can prevent the user from feeling uncomfortable. Therefore, the information processing apparatus 10 can control the display properly when controlling the display by splitting the screen area of the display 150 into two or more display areas.

### Second Embodiment

Next, a second embodiment of the present invention will be described.

In the first embodiment, the control when the transition from the one-screen mode or the two-screen mode to the half-screen mode is made is described, while in one or more embodiments, control when the transition from a three-screen mode or a four-screen mode to the half-screen mode is made will be described. For example, the information processing apparatus 10 may have the three-screen mode or the four-screen mode in addition to the two-screen mode by splitting either one or both of the first screen area DA1 and the second screen area DA2 into two display areas.

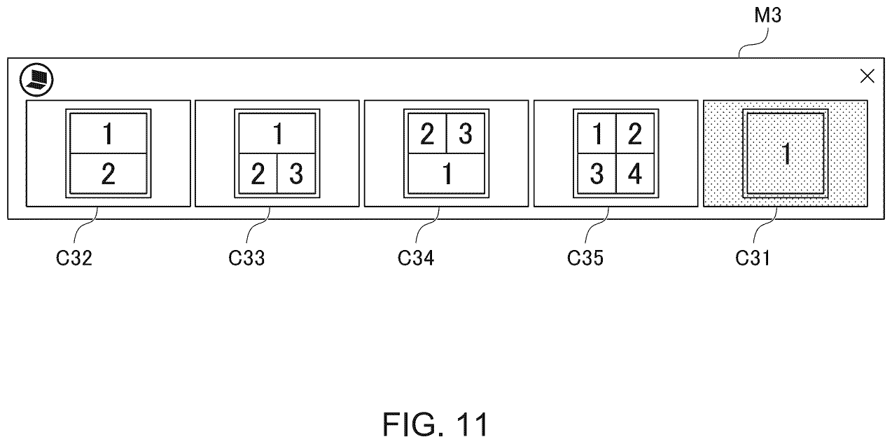

FIG. 11 is a diagram illustrating an example of operation specifications of display mode switching operations according to one or more embodiments. FIG. 11 illustrates an example of a switching menu M3 displayed by the user operating the icon C1 illustrated in FIG. 5A, for example. The switching menu M3 is displayed when the usage form is “Clamshell” (the display mode (c-1), the display mode (e), the display mode (e′), or the like), which is different from FIG. 5C in that switching to the three-screen mode and the four-screen mode are enabled.

On the switching menu M3, display mode switching icons C31, C32, C33, C34, and C35 are displayed. The display mode switching icon C31 is displayed as an operating element for selecting the display mode (e) or the display mode (e′) of the one-screen mode. The display mode switching icon C32 is displayed as an operating element for selecting the display mode (c-1) of the two-screen mode. Each of the display mode switching icon C33 and the display mode switching icon C34 is displayed as an operating element for selecting a display mode of the three-screen mode, respectively. The display mode switching icon C33 and the display mode switching icon C34 are different in whether the second screen area DA2 is split into two display areas “2” and “3” or the first screen area DA1 is split into two display areas “2” and “3.” The display mode switching icon C35 is displayed as an operating element for selecting a display mode of the four-screen mode.

When the user performs an operation to select the display mode switching icon C33 or the display mode switching icon C34, the display of the switching menu is ended, and the display mode is controlled to the three-screen mode. Further, when the user performs an operation to select the display mode switching icon C35, the display of the switching menu is ended, and the display mode is controlled to the four-screen mode.

Note that FIG. 11 illustrates an example in which the operating elements for selecting the three-screen mode and the four-screen mode are added to the switching menu M2 illustrated in FIG. 5C, but the operating elements for selecting the three-screen mode and the four-screen mode may also be added to the switching menu M1 illustrated in FIG. 5B in the same way.

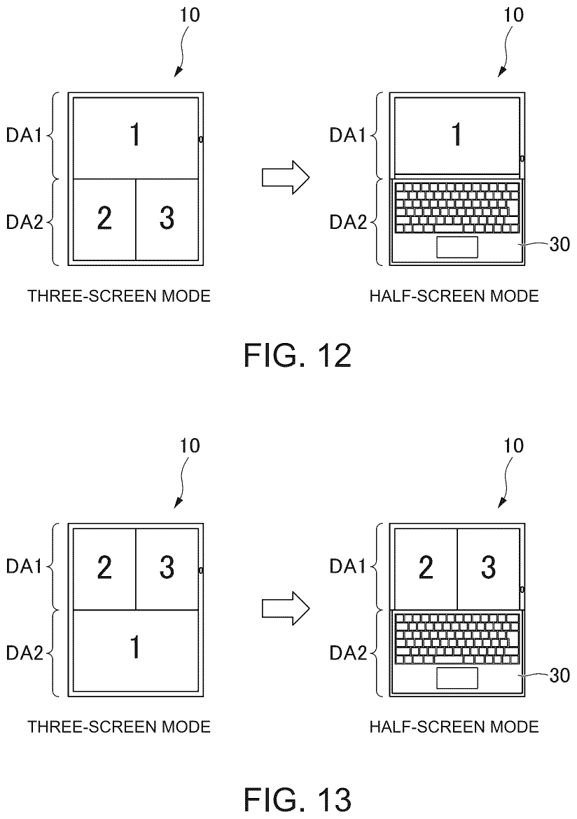

FIG. 12 is a diagram illustrating a first example of control from the three-screen mode to the half-screen mode according to one or more embodiments. In the illustrated three-screen mode, the control unit 18 in the information processing apparatus 10 further splits, into two display areas, the second screen area DA2 obtained by splitting the screen area DA into two display areas of the first screen area DA1 and the second screen area DA2 in the two-screen mode, and controls the display in three display areas of a display area “1” of the first screen area DA1 and two display areas “2” and “3” of the second screen area DA2.

When the transition to the half-screen mode is made, the control unit 18 targets only the first screen area DA1 (the display area “1”) for display, and maintains a window displayed in the first screen area DA1 (the display area “1”) in the three-screen mode. Further, the control unit 18 arranges windows, displayed respectively in the two display areas “2” and “3” of the second screen area DA2 in the three-screen mode, on layers lower than a window displayed on the top layer of the first screen area DA1 (the display area “1”).

Further, when an active window is displayed in either one of the two display areas “2” and “3” of the second screen area DA2 in the three-screen mode, the control unit 18 may switch, to an active window, the window displayed on the top layer of the first screen area DA1 (the display area “1”) in the three-screen mode in response to switching to the half-screen mode. Note that, when the active window is displayed in the first screen area DA1 (the display area “1”) in the three-screen mode, the control unit 18 maintains the display of the active window after switching to the half-screen mode. In other words, the control unit 18 may set the window displayed on the top layer of the first screen area DA1 (display area “1”) as an active window after switching to the half-screen mode regardless of in which of the first screen area DA1 (the display area “1”) and the second screen area DA2 (the display area “2” or the display area “3”) the active window was displayed in the three-screen mode.

Note that, when the transition from the three-screen mode to the half-screen mode is made, the control unit 18 may minimize, in the first screen area DA1, windows displayed in the two display areas of the display area “2” and the display area “3” of the second screen area DA2 in the three-screen mode.

Thus, in the information processing apparatus 10 according to one or more embodiments, when the display is controlled in the display control processing by splitting the display area of the second screen area DA2 (an example of a display area other than the first screen area DA1) in the three-screen mode (another example of the second display mode) into two or more display areas (for example, the two display areas “2” and “3”), the control unit 18 arranges or minimizes windows, displayed respectively in the two display areas “2” and “3” of the second screen area DA2 in the three-screen mode, on layers lower than the window displayed on the top layer of the first screen area DA1 (the display area “1”) in the three-screen mode in response to switching from the three-screen mode to the half-screen mode (the example of the third display mode).

Thus, when the transition from the three-screen mode to the half-screen mode is made by the fact that the keyboard 30 is mounted, since the display state of the window of the first screen area DA1 on the side where the keyboard 30 is not mounted is maintained, the information processing apparatus 10 can prevent the user from feeling uncomfortable. Therefore, the information processing apparatus 10 can control the display properly when controlling the display by splitting the screen area of the display 150 into two or more display areas.

FIG. 13 is a diagram illustrating a second example of control from the three-screen mode to the half-screen mode according to one or more embodiments. In the illustrated three-screen mode, the control unit 18 in the information processing apparatus 10 further splits, into two display areas, the first screen area DA1 obtained by splitting the screen area DA into two display areas of the first screen area DA1 and the second screen area DA2 in the two-screen mode, and controls the display in three display areas of two display areas “2” and “3” of the first screen area DA1 and a display area “1” of the second screen area DA2.

When the transition to the half-screen mode is made, the control unit 18 targets only the first screen area DA1 (the display areas “2” and “3”) for display, and maintains windows displayed respectively in the two display areas “2” and “3” of the first screen area DA1 in the three-screen mode. Further, the control unit 18 arranges a window, displayed in the second screen area DA2 (the display area “1”) in the three-screen mode, on a layer lower than the windows displayed respectively on the top layers of the display areas “2” and “3” in the first screen area DA1.

Further, when an active window is displayed in the display area “1” of the second screen area DA2 in the three-screen mode, the control unit 18 may switch, to an active window, a window displayed on the top layer of the display area “2” or “3” inside the first screen area DA1 in the three-screen mode in response to switching to the half-screen mode. Note that, when an active window is displayed in the first screen area DA1 (the display area “2” or the display area “3”) in the three-screen mode, the control unit 18 maintains the display of the active window after switching to the half-screen mode. In other words, after switching to the half-screen mode, the control unit 18 may set, as an active window, a window displayed on the top layer of the first screen area DA1 (the display area “2” or “3”) regardless of in which of the first screen area DA1 (the display area “2” or the display area “3”) and the second screen area DA2 (the display area “1”) the active window was displayed in the three-screen mode.

Note that, when the transition from the three-screen mode to the half-screen mode is made, the control unit 18 may minimize, in either one of the display areas “2” and “3” of the first screen area DA1, a window displayed in the second screen area DA2 (the display area “1”) in the three-screen mode.

Thus, when the display is controlled in the display control processing by splitting the first screen area DA1 into two or more display areas (for example, into the two display areas “2” and “3”) in the three-screen mode, the information processing apparatus 10 arranges or minimizes a window, arranged in the display area “1” of the second screen area DA2 (the example of the display area other than the first screen area DA1) in the three-screen mode, on a layer lower than the windows displayed on the top layers of the respective display areas inside the first screen area DA1 in the three-screen mode in response to switching from the three-screen mode to the half-screen mode.

Thus, when the transition from the three-screen mode to the half-screen mode is made by the fact that the keyboard 30 is mounted, since the display state of the windows of the first screen area DA1 on the side where the keyboard 30 is not mounted is maintained, the information processing apparatus 10 can prevent the user from feeling uncomfortable. Therefore, the information processing apparatus 10 can control the display properly when controlling the display by splitting the screen area of the display 150 into two or more display areas.

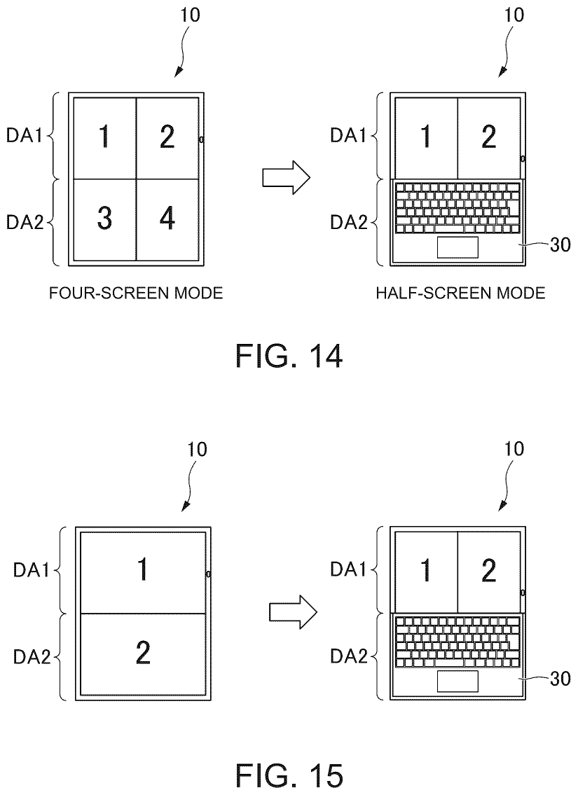

FIG. 14 is a diagram illustrating control from the four-screen mode to the half-screen mode according to one or more embodiments. In the illustrated four-screen mode, the control unit 18 in the information processing apparatus 10 further splits, into two display areas, each of the first screen area DA1 and the second screen area DA2 obtained by splitting the screen area DA into two display areas of the first screen area DA1 and the second screen area DA2 in the two-screen mode, and controls the display in four display areas of two display areas “1” and “2” of the first screen area DA1 and two display areas “3” and “4” of the second screen area DA2.

When the transition to the half-screen mode is made, the control unit 18 targets only the first screen area DA1 (the display areas “1” and “2”) for display to maintain windows displayed respectively in the two display areas “1” and “2” of the first screen area DA1 in the four-screen mode. Further, the control unit 18 arranges windows, displayed in the second screen area DA2 (in the display areas “3” and “4”) in the four-screen mode, on layers lower than windows displayed on the top layers of the respective display areas “1” and “2” in the first screen area DA1.

Further, when an active window is displayed in the display area “3” or the display area “4” of the second screen area DA2 in the four-screen mode, the control unit 18 may switch, to an active window, a window displayed on the top layer of the display area “1” or “2” inside the first screen area DA1 in the four-screen mode in response to switching to the half-screen mode. Note that, when an active window is displayed in the first screen area DA1 (in the display area “1” or the display area “2”) in the four-screen mode, the control unit 18 maintains the display of the active window after switching to the half-screen mode. In other words, after switching to the half-screen mode, the control unit 18 may set, as an active window, a window displayed on the top layer of the first screen area DA1 (the display area “1” or “2”) regardless of in which of the first screen area DA1 (the display area “1” or the display area “2”) and the second screen area DA2 (the display area “3” or the display area “4”) an active window was displayed in the four-screen mode.

Note that, when the transition from the four-screen mode to the half-screen mode is made, the control unit 18 may minimize, in either one of the display areas “1” and “2” of the first screen area DA1, windows displayed in the second screen area DA2 (the display areas “3” and “4”) in the four-screen mode.

Thus, in the display control processing, when the display is controlled by splitting each of the display areas of the first screen area DA1 and the second screen area DA2 into two display areas, respectively, in the four-screen mode (still another example of the second display mode), the control unit 18 arranges or minimizes windows, displayed respectively in the two display areas “3” and “4” of the second screen area DA2 in the four-screen mode, on layers lower than windows displayed on the top layers of the respective display areas “1” and “2” inside the first screen area DA1 in the four-screen mode in response to switching from the four-screen mode to the half-screen mode.

Thus, when the transition to the half-screen mode is made by the fact that the keyboard 30 is mounted, since the display state of the windows of the first screen area DA1 on the side where the keyboard 30 is not mounted is maintained, the information processing apparatus 10 can prevent the user from feeling uncomfortable. Therefore, the information processing apparatus 10 can control the display properly when controlling the display by splitting the screen area of the display 150 into two or more display areas.

### Third Embodiment

Next, a third embodiment of the present invention will be described.

In the first embodiment, the control of maintaining the display of the first screen area DA1 when switching from the two-screen mode to the half-screen mode is described, while in one or more embodiments, control of arranging windows, displayed respectively in the first screen area DA1 and the second screen area DA2 in the two-screen mode, in two display areas of the first screen area DA1, respectively, by splitting the first screen area DA1 into the two display areas in the half-screen mode will be described.

FIG. 15 is a diagram illustrating an example of control from the two-screen mode to the half-screen mode according to one or more embodiments. In the information processing apparatus 10, the control unit 18 controls the display in the two-screen mode by splitting the screen area DA into two display areas (display area “1” and display area “2”) of the first screen area DA1 and the second screen area DA2. When the transition to the half-screen mode is made, the control unit 18 targets only the first screen area DA1 for display and splits the first screen area DA1 into two display areas “1” and “2.” Then, the control unit 18 arranges windows displayed in the two-screen mode, that is, a window displayed in the first screen area DA1 (the display area “1”) and a window displayed in the second screen area DA2 (the display area “2”), respectively, in two display areas of the display area “1” and the display area “2” of the first screen area DA1 in the half-screen mode.

At this time, the control unit 18 may maintain an active window in the two-screen mode after switching to the half-screen mode, or may set, as an active window, the window displayed on the top layer of the display area “1” of the first screen area DA1 in the two-screen mode after switching to the half-screen mode.

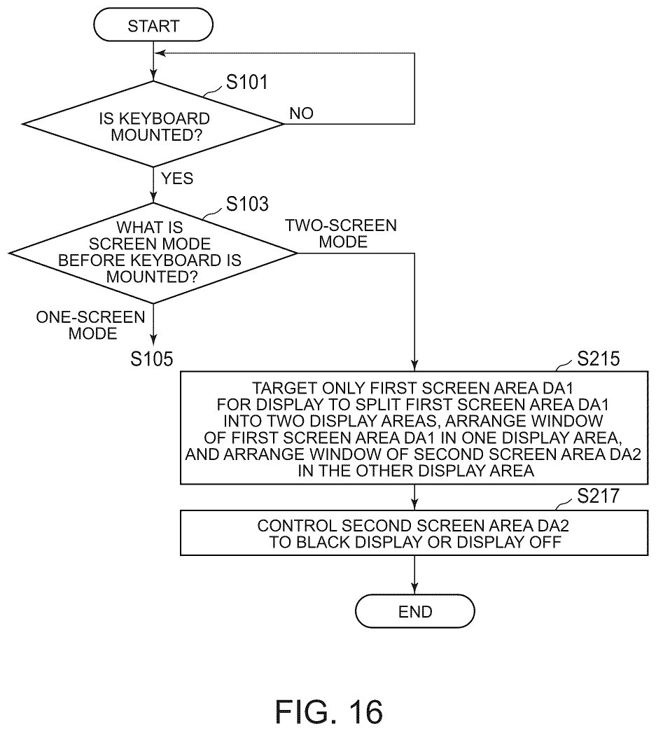

Next, the operation of half-screen mode switching processing in which the control unit 18 switches from the two-screen mode to the half-screen mode in one or more embodiments will be described. First, the operation of half-screen mode switching processing when the active window in the two-screen mode is maintained after switching to the half-screen mode will be described with reference to FIG. 16.

FIG. 16 is a flowchart illustrating a first example of half-screen mode switching processing according to one or more embodiments. In FIG. 16, since processes in step S101 and step S103 are the same as the processes in step S101 and step S103 of FIG. 10, the description thereof will be omitted. When determining in step S103 that the screen mode before the keyboard 30 is mounted is the two-screen mode, the control unit 18 proceeds to a process in step S215.

(Step S215) The control unit 18 switches to the half-screen mode in which only the first screen area DA1 is targeted for display. For example, the control unit 18 splits the first screen area DA1 into two display areas “1” and “2” to arrange, in one display area “1,” a window displayed in the first screen area DA1 in the two-screen mode and arrange, in the other display area “2,” a window displayed in the second screen area DA2 in the two-screen mode. Then, the control unit 18 proceeds to a process in step S217.

(Step S217) The control unit 18 controls the second screen area DA2 to black display or display off, and ends the half-screen mode switching processing.

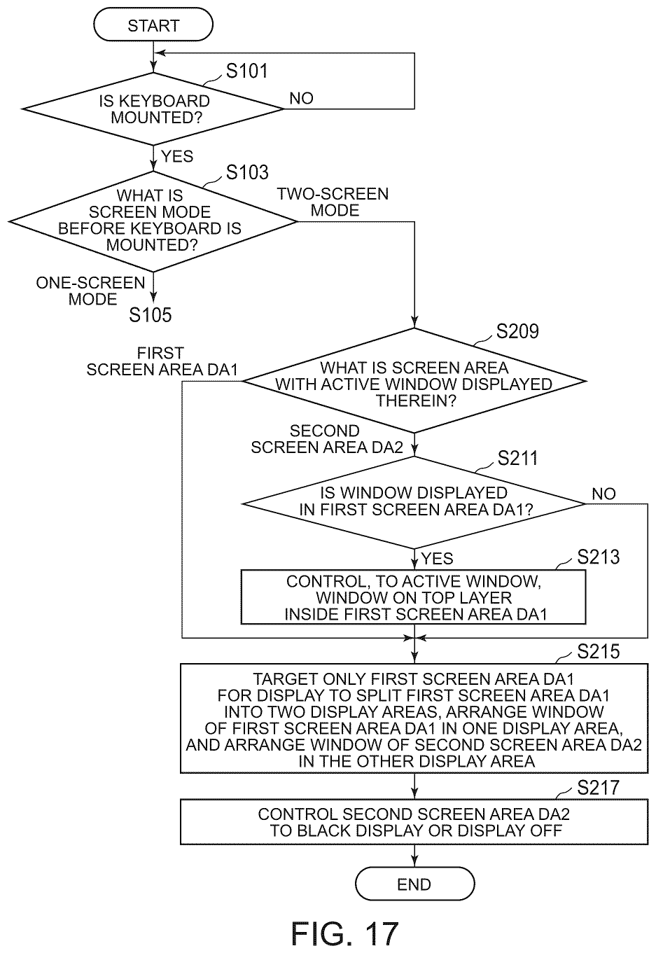

Next, the operation of half-screen mode switching processing when a window displayed on the top layer of the display area “1” of the first screen area DA1 in the two-screen mode is set to an active window after switching to the half-screen mode will be described with reference to FIG. 17.

FIG. 17 is a flowchart illustrating a second example of half-screen mode switching processing according to one or more embodiments. In FIG. 17, since processes in step S101 and step S103 are the same as the processes in step S101 and step S103 of FIG. 10, the description thereof will be omitted. When determining in step S103 that the screen mode before the keyboard 30 is mounted is the two-screen mode, the control unit 18 proceeds to a process in step S209.

(Step S209) The control unit 18 determines a screen area in which an active window is displayed in the two-screen mode before the keyboard 30 is mounted. When the screen area with the active window displayed therein is the second screen area DA2, the control unit 18 proceeds to a process in step S211. On the other hand, when the screen area with the active window displayed therein is the first screen area DA1, the control unit 18 proceeds to a process in step S215.

(Step S211) When the active window is displayed in the second screen area DA2, the control unit 18 determines whether or not any window is displayed in the first screen area DA1. When determining that any window is displayed in the first screen area DA1 (YES), the control unit 18 proceeds to a process in step S213. On the other hand, when determining that no window is displayed in the first screen area DA1 (NO), the control unit 18 proceeds to the process in step S215.

(Step S213) The control unit 18 controls, to an active window, a window arranged on the top layer inside the first screen area DA1, and controls the active window displayed in the second screen area DA2 to an inactive window. Then, the control unit 18 proceeds to the process in step S215 to switch to the half-screen mode. Note that since the processes in and after step S215 are the same as the processes in FIG. 16, the description thereof will be omitted.

Thus, when an active window is displayed in the second screen area DA2 in the two-screen mode, the window arranged on the top layer inside the first screen area DA1 is set to an active window to switch to the half-screen mode. In other words, in the half-screen mode, the active window is displayed on the side of the display area “1” inside the first screen area DA illustrated in FIG. 15.

Note that, even when the active window is displayed in the second screen area DA2 in the two-screen mode, if no window is displayed inside the first screen area DA1, the screen mode will be switched to the half-screen mode without changing the active window. In other words, in the half-screen mode, the active window is displayed on the side of the display area “2” inside the first screen area DA1 illustrated in FIG. 15.

As described above, in the information processing apparatus 10 according to one or more embodiments, the control unit 18 performs mounting detection processing to detect the mounting (connection) of the external keyboard 30 on (to) the second screen area DA2 (the example of the predetermined screen area) within the screen area of the display 150. Further, the control unit 18 performs display control processing to control switching among the one-screen mode (the example of the first display mode) in which the display is controlled by setting the entire screen area DA of the display 150 as one display area, the two-screen mode (the example of the second display mode) in which the display is controlled by splitting the screen area DA of the display 150 into two display areas of the first screen area DA1 (a screen area that does not contain the second screen area DA2) and the second screen area DA2, and the half-screen mode (the example of the third display mode) in which, when the mounting of the keyboard 30 is detected by the mounting detection processing, the display is controlled using, as the display area, only the first screen area DA1 of the first screen area DA1 and the second screen area DA2. Then, in the display control processing, the control unit 18 splits the first screen area DA1 into the two display areas “1” and “2” in response to switching from the two-screen mode to the half-screen mode to display a window, displayed in the first screen area DA1 in the two-screen mode, in one display area “1” of the two display areas, and display a window, displayed in the second screen area DA2 (other than the first screen area DA1), in the other display area “2.”

Thus, when the transition from the two-screen mode to the half-screen mode is made by the fact that the keyboard 30 is mounted, since not only the window of the first screen area DA on the side where the keyboard 30 is not mounted, but also the window of the second screen area DA2 on the side where the keyboard 30 is mounted are displayed in the first screen area DA1, the information processing apparatus 10 is convenient for the user. Therefore, the information processing apparatus 10 can control the display properly when controlling the display by splitting the screen area of the display 150 into two or more display areas.

Further, a control method for the information processing apparatus 10 according to one or more embodiments includes: a mounting detection step of causing the control unit 18 to detect the mounting (connection) of the external keyboard 30 on (to) the second screen area DA2 (the example of the predetermined screen area) within the screen area of the display 150; and a display control step of causing the control unit 18 to control switching among the one-screen mode (the example of the first display mode) in which the display is controlled by setting the entire screen area DA of the display 150 as one display area, the two-screen mode (the example of the second display mode) in which the display is controlled by splitting the screen area DA of the display 150 into two display areas of the first screen area DA1 (the screen area that does not contain the second screen area DA2) and the second screen area DA2, and the half-screen mode (the example of the third display mode) in which, when the mounting of the keyboard 30 is detected by the mounting detection step, the display is controlled using, as the display area, only the first screen area DA1 of the first screen area DA1 and the second screen area DA2. Then, in the display control step, the control unit 18 splits the first screen area DA1 into the two display areas “1” and “2” in response to switching from the two-screen mode to the half-screen to display a window, displayed in the first screen area DA in the two-screen mode, in one display area “1” of the two display areas, and display a window, displayed in the second screen area DA2 (other than the first screen area DA1), in the other display area “2.”

Thus, when the transition from the two-screen mode to the half-screen mode is made by the fact that the keyboard 30 is mounted, since not only the window of the first screen area DA1 on the side where the keyboard 30 is not mounted, but also the window of the second screen area DA2 on the side where the keyboard 30 is mounted are displayed in the first screen area DA1, the information processing apparatus 10 is convenient for the user. Therefore, the information processing apparatus 10 can control the display properly when controlling the display by splitting the screen area of the display 150 into two or more display areas.

While the embodiments of this invention have been described in detail with reference to the accompanying drawings, the specific configurations are not limited to those described above, and various design changes and the like can be made without departing from the scope of this invention. For example, the configurations described in the respective embodiments mentioned above may be combined arbitrarily.

Note that in the half-screen mode, the orientation of the display of the first screen area DA1 is controlled to a preset display orientation regardless of the orientation of the screen areas of the display 150. The preset display orientation is an orientation in which the side on which the first chassis 101 and the second chassis 102 are connected in the first screen area DA1 is downward, that is, an orientation in which the side opposite to the side on which the first chassis 101 and the second chassis 102 are connected in the first screen area DA1 is upward. The connection between the first chassis 101 and the second chassis 102 is a section in which the first chassis 101 and the second chassis 102 are joined (coupled) through the hinge mechanism 103, which corresponds to a section in which the screen area DA of the display 150 is split into the first screen area DA1 and the second screen area DA2 in the two-screen mode. In other words, in the half-screen mode, the display orientation of the first screen area DA1 is controlled to be able to use the information processing apparatus 10 in such a state that the first chassis 101 with the camera 16 provided thereon is above the second chassis 102 with the keyboard 30 mounted thereon.

Further, in the aforementioned embodiments, the example in which the connection with (mounting of) the keyboard 30 is detected using the Hall sensor 17 is described, but the detection method is not limited to this example. For example, a photo sensor, a mechanical switch, or the like may be used to detect the connection with (mounting of) the keyboard 30.

Further, in the embodiments described above, the display 150 is a foldable one display, and the example in which the one display is used in the one-screen mode, multi-screen modes (the two-screen mode, the three-screen mode, and the four-screen mode), or the half-screen mode is described, but the display 150 may also be configured to include two or more (for example, two) displays. For example, the display mode can be set to the one-screen mode in which respective screen areas of the two displays are brought together as the screen area DA to control display, and to the two-screen mode in which the display of each of screen areas of the two displays is controlled individually. Further, as the half-screen mode, the processing in each of the embodiments described above can also be applied in such a manner that only one of the two displays is targeted for display and the other is controlled to black display or display off. Further, the two displays can also be used as the three-screen mode or the four-screen mode by splitting either one or both of the two displays into two display areas.

Further, in the embodiments described above, the example of touch operations on the multi-touch panel type display constructed by integrating the input unit (touch sensor) and the display unit together is described, but operations are not limited to the touch operations, and the operations may also be click operations with a mouse, operations with gestures, and the like.

Note that the information processing apparatus 10 described above has a computer system therein. Then, a program for implementing the function of each component included in the information processing apparatus 10 described above may be recorded on a computer-readable recording medium so that the program recorded on this recording medium is read into the computer system and executed to perform processing in each component included in the information processing apparatus 10 described above. Here, the fact that “the program recorded on the recording medium is read into the computer system and executed” includes installing the program on the computer system. It is assumed that the “computer system” here includes the OS and hardware such as peripheral devices and the like. Further, the “computer system” may also include two or more computers connected through networks including the Internet, WAN, LAN, and a communication line such as a dedicated line. Further, the “computer-readable recording medium” means a storage medium such as a flexible disk, a magneto-optical disk, a portable medium like a flash ROM or a CD-ROM, or a hard disk incorporated in the computer system. Thus, the recording medium with the program stored thereon may be a non-transitory recording medium such as the CD-ROM.

Further, a recording medium internally or externally provided to be accessible from a delivery server for delivering the program is included as the recording medium. Note that the program may be split into plural pieces, downloaded at different timings, respectively, and then united in each component included in the information processing apparatus 10, or delivery servers for delivering respective split pieces of the program may be different from one another. Further, it is assumed that the “computer-readable recording medium” includes a medium on which the program is held for a given length of time, such as a volatile memory (RAM) inside a computer system as a server or a client when the program is transmitted through a network. The above-mentioned program may also be to implement some of the functions described above. Further, the program may be a so-called differential file (differential program) capable of implementing the above-described functions in combination with a program(s) already recorded in the computer system.

Further, some or all of the functions of the information processing apparatus 10 in the embodiments described above may be realized as an integrated circuit such as LSI (Large Scale Integration). Each function may be implemented by a processor individually, or some or all of the functions may be integrated as a processor. Further, the method of circuit integration is not limited to LSI, and it may be realized by a dedicated circuit or a general-purpose processor. Further, if integrated circuit technology replacing the LSI appears with the progress of semiconductor technology, an integrated circuit according to the technology may be used.

### DESCRIPTION OF SYMBOLS

10 information processing apparatus
101 first chassis
102 second chassis
103 hinge mechanism
11 communication unit
12 RAM
13 storage unit
14 speaker
15 display unit
16 camera
150 display
155 touch sensor
161 first acceleration sensor
162 second acceleration sensor
17 Hall sensor
18 control unit
181 system processing unit
1811 running app information generating unit
182 detection processing unit
1821 open/close detection unit
1822 posture detection unit
1823 connection detection unit
1824 operation detection unit
183 display processing unit
1831 display mode determination unit
1832 display mode switching unit
1834 display control unit

What is claimed is:

1. An information processing apparatus comprising:
a memory which temporarily stores a program of an application;
a display; and
a processor which executes the program of the application stored in the memory to perform control to display a window of the application on the display, wherein
the processor performs
mounting detection processing to detect mounting of an external keyboard on a predetermined screen area within a screen area of the display, and
display control processing to control switching among a first display mode in which display is controlled using an entire screen area of the display as one display area, a second display mode in which the display is controlled by splitting the screen area of the display into two or more display areas, and a third display mode in which, when the mounting of the keyboard is detected by the mounting detection processing, the display is controlled using, as a display area, a first screen area as part of the screen area of the display except the predetermined screen area, and
in the display control processing, when switching from the second display mode to the third display mode, the processor arranges or minimizes, in the first screen area, a window displayed in a display area other than the first screen area in the second display mode, and when arranging the window in the first screen area, the processor arranges the window on a layer lower than a window displayed on a top layer of the first screen area in the second display mode.

2. The information processing apparatus according to claim 1, wherein in the display control processing, when an active window is displayed in a display area other than the first screen area in the second display mode, the processor switches, to an active window, the window displayed on the top layer of the first screen area in the second display mode in response to switching from the second display mode to the third display mode.

3. The information processing apparatus according to claim 1, wherein in the display control processing, when the display is controlled by splitting the display area other than the first screen area into two or more display areas in the second display mode, the processor arranges or minimizes windows, displayed respectively in the two or more display areas other than the first screen area in the second display mode, on layers lower than the window displayed on the top layer of the first screen area in the second display mode in response to switching from the second display mode to the third display mode.

4. The information processing apparatus according to claim 1, wherein in the display control processing, when the display is controlled by splitting the first screen area into two or more display areas in the second display mode, the processor arranges or minimizes a window, displayed in the display area other than the first screen area in the second display mode, on a layer lower than windows displayed on the top layers of the respective display areas inside the first screen area in the second display mode in response to switching from the second display mode to the third display mode.

5. The information processing apparatus according to claim 1, wherein in the display control processing, when the display is controlled by splitting the first screen area and the display area other than the first screen area respectively into two or more display areas in the second display mode, the processor arranges or minimizes windows, displayed respectively in the two or more display areas other than the first screen area in the second display mode, on layers lower than windows displayed on the top layers of the respective display areas inside the first screen area in the second display mode in response to switching from the second display mode to the third display mode.

6. An information processing apparatus comprising:
a memory which temporarily stores a program of an application;
a display; and
a processor which executes the program of the application stored in the memory to perform control to display a window of the application on the display, wherein
the processor performs
mounting detection processing to detect mounting of an external keyboard on a predetermined screen area within a screen area of the display, and
display control processing to control switching among a first display mode in which display is controlled using an entire screen area of the display as one display area, a second display mode in which the display is controlled by splitting the screen area of the display into two or more display areas, and a third display mode in which, when the mounting of the keyboard is detected by the mounting detection processing, the display is controlled using, as a display area, a first screen area as part of the screen area of the display except the predetermined screen area, and
in the display control processing, when an active window is displayed in a display area other than the first screen area in the second display mode upon switching from the second display mode to the third display mode, the processor switches, to an active window, a window displayed on the a layer of the first screen area in the second display mode.

7. The information processing apparatus according to claim 6, wherein in the display control processing, when the display is controlled by splitting the screen area of the display into two display areas in the second display mode, the processor splits the first screen area into two display areas to display, in one display area of the two display areas, a window displayed in the first screen area in the second display mode, and display, in the other display area, a window displayed in a display area other than the first screen area in response to switching from the second display mode to the third display mode.

8. An information processing apparatus comprising:
a memory which temporarily stores a program of an application;
a display; and
a processor which executes the program of the application stored in the memory to perform control to display a window of the application on the display, wherein
the processor performs
mounting detection processing to detect mounting of an external keyboard on a predetermined screen area within a screen area of the display, and
display control processing to control switching among a first display mode in which display is controlled using an entire screen area of the display as one display area, a second display mode in which the display is controlled by splitting the screen area of the display into two display areas of a first screen area that does not contain the predetermined screen area and a second screen area that contains the predetermined screen area, and a third display mode in which, when the mounting of the keyboard is detected by the mounting detection processing, the display is controlled using, as a display area, only the first screen area of the first screen area and the second screen area, and
in the display control processing, the processor splits the first screen area into two display areas in response to switching from the second display mode to the third display mode to display, in one display area of the two display areas, a window displayed in the first screen area in the second display mode, and display, in the other display area, a window displayed in the second screen area.

9. The information processing apparatus according to claim 1, wherein when the display mode is controlled to the third display mode by the display control processing, the processor controls a display area that contains at least the predetermined screen area to black display or display off.

10. The information processing apparatus according to claim 1, wherein the display is foldable one display.

11. The information processing apparatus according to claim 1, wherein the display includes two or more displays.

12. A control method for an information processing apparatus including: a memory which temporarily stores a program of an application; a display; and a processor which executes the program of the application stored in the memory to perform control to display a window of the application on the display, the control method comprising:
a mounting detection step of causing the processor to detect mounting of an external keyboard on a predetermined screen area within a screen area of the display; and
a display control step of causing the processor to control switching among a first display mode in which display is controlled using an entire screen area of the display as one display area, a second display mode in which the display is controlled by splitting the screen area of the display into two or more display areas, and a third display mode in which, when the mounting of the keyboard is detected by the mounting detection step, the display is controlled using, as a display area, a first screen area as part of the screen area of the display except the predetermined screen area,
wherein in the display control step, when switching from the second display mode to the third display mode, the processor arranges or minimizes, in the first screen area, a window displayed in a display area other than the first screen area in the second display mode, and when arranging the window in the first screen area, the processor arranges the window on a layer lower than a window displayed on a top layer of the first screen area in the second display mode.

13. A control method for an information processing apparatus including: a memory which temporarily stores a program of an application; a display; and a processor which executes the program of the application stored in the memory to perform control to display a window of the application on the display, the control method comprising:
a mounting detection step of causing the processor to detect mounting of an external keyboard on a predetermined screen area within a screen area of the display; and
a display control step of causing the processor to control switching among a first display mode in which display is controlled using an entire screen area of the display as one display area, a second display mode in which the display is controlled by splitting the screen area of the display into two or more display areas, and a third display mode in which, when the mounting of the keyboard is detected by the mounting detection step, the display is controlled using, as a display area, a first screen area as part of the screen area of the display except the predetermined screen area,
wherein in the display control step, when an active window is displayed in a display area other than the first screen area in the second display mode upon switching from the second display mode to the third display mode, the processor switches, to an active window, a window displayed on a top layer of the first screen area in the second display mode.

14. A control method for an information processing apparatus including: a memory which temporarily stores a program of an application; a display; and a processor which executes the program of the application stored in the memory to perform control to display a window of the application on the display, the control method comprising:
a mounting detection step of causing the processor to detect mounting of an external keyboard on a predetermined screen area within a screen area of the display; and
a display control step of causing the processor to control switching among a first display mode in which display is controlled using an entire screen area of the display as one display area, a second display mode in which the display is controlled by splitting the screen area of the display into two display areas of a first screen area that does not contain the predetermined screen area and a second screen area that contains the predetermined screen area, and a third display mode in which, when the mounting of the keyboard is detected by the mounting detection step, the display is controlled using, as a display area, only the first screen area of the first screen area and the second screen area,
wherein in the display control step, the processor splits the first screen area into two display areas in response to switching from the second display mode to the third display mode to display, in one display area of the two display areas, a window displayed in the first screen area in the second display mode, and display, in the other display area, a window displayed in the second screen area.
